(19) United States
(12) Patent Application Publication
(10) Pub. No.: US 2021/0134049 A1
(43) Pub. Date: May 6, 2021

(54) IMAGE PROCESSING APPARATUS AND METHOD

(71) Applicant: SONY CORPORATION, Tokyo (JP)

(72) Inventor: Hisako SUGANO, Kanagawa (JP)

(73) Assignee: SONY CORPORATION, Tokyo (JP)

(21) Appl. No.: 16/635,800

(22) PCT Filed: Jul. 26, 2018
(86) PCT No.: PCT/JP2018/028033

§ 371 Date: Jan. 31, 2020

(30) Foreign Application Priority Data
Aug. 8, 2017 (JP) 2017-153129

(51) Int. Cl. G06T 15/20; G06T 15/60

(52) U.S. Cl. CPC G06T 15/20; G06T 2215/12; G06T 15/60

(57) ABSTRACT

There is provided an image processing apparatus and an image processing method that enable transmission of a three-dimensional model of a subject and shadow information of the subject in a separate manner. A generator of an encoding system generates two-dimensional image data and depth data on the basis of a three-dimensional model generated from each of viewpoint images of a subject. The viewpoint images are captured through imaging from a plurality of viewpoints and subjected to a shadow removal process. A transmitter of the encoding system transmits the two-dimensional image data, the depth data, and information related to a shadow of the subject to a decoding system. The present technology is applicable to a free-viewpoint image transmission system.

### TECHNICAL FIELD

The present technology relates to an image processing apparatus and an image processing method. In particular, the present technology relates to an image processing apparatus and an image processing method that enable transmission of a three-dimensional model of a subject and shadow information of the subject in a separate manner.

### BACKGROUND ART

PTL 1 proposes that a three-dimensional model generated from viewpoint images captured by a plurality of cameras is converted to two-dimensional image data and depth data, and the data is encoded and transmitted. According to this proposal, the two-dimensional image data and the depth data are used to reconstruct (are converted to) a three-dimensional model at a displaying end, and the reconstructed three-dimensional model is displayed by being projected.

### CITATION LIST

### Patent Literature

PTL 1: WO 2017/082076

### SUMMARY OF THE INVENTION

### Problems to be Solved by the Invention

However, according to the proposal of PTL 1, the three-dimensional model includes a subject and a shadow at the time of imaging. Therefore, when the three-dimensional model of the subject is reconstructed at the displaying end on the basis of the two-dimensional image data and the depth data into three-dimensional space that is different from three-dimensional space in which the imaging has been performed, the shadow at the time of the imaging is also projected. That is, to generate a display image, the three-dimensional model and the shadow at the time of the imaging are projected to the three-dimensional space that is different from the three-dimensional space in which the imaging has been performed. This makes the display image be displayed unnatural.

The present technology has been achieved in view of the above-described circumstances to enable transmission of a three-dimensional model of a subject and shadow information of the subject in a separate manner.

### Means for Solving the Problems

An image processing apparatus according to an aspect of the present technology includes a generator and a transmitter. The generator generates two-dimensional image data and depth data on the basis of a three-dimensional model generated from each of viewpoint images of a subject. The viewpoint images are captured through imaging from a plurality of viewpoints and subjected to a shadow removal process. The transmitter transmits the two-dimensional image data, the depth data, and shadow information being information related to a shadow of the subject.

An image processing method according to the aspect of the present technology includes generating and transmitting. In the generating, an image processing apparatus generates two-dimensional image data and depth data on the basis of a three-dimensional model generated from each of viewpoint images of a subject. The viewpoint images are captured through imaging from a plurality of viewpoints and subjected to a shadow removal process. In the transmitting, the image processing apparatus transmits the two-dimensional image data, the depth data, and shadow information being information related to a shadow of the subject.

According to the aspect of the present technology, two-dimensional image data and depth data are generated on the basis of a three-dimensional model generated from each of viewpoint images of a subject. The viewpoint images are captured through imaging from a plurality of viewpoints and subjected to a shadow removal process. The two-dimensional image data, the depth data, and shadow information being information related to a shadow of the subject are transmitted.

An image processing apparatus according to another aspect of the present technology includes a receiver and a display image generator. The receiver receives two-dimensional image data, depth data, and shadow information. The two-dimensional image data and the depth data are generated on the basis of a three-dimensional model generated from each of viewpoint images of a subject. The viewpoint images are captured through imaging from a plurality of viewpoints and subjected to a shadow removal process. The shadow information is information related to a shadow of the subject. The display image generator generates a display image exhibiting the subject from a predetermined viewpoint, using the three-dimensional model reconstructed on the basis of the two-dimensional image data and the depth data.

An image processing method according to the other aspect of the present technology includes receiving and generating. In the receiving, an image processing apparatus receives two-dimensional image data, depth data, and shadow information. The two-dimensional image data and the depth data are generated on the basis of a three-dimensional model generated from each of viewpoint images of a subject. The viewpoint images are captured through imaging from a plurality of viewpoints and subjected to a shadow removal process. The shadow information is information related to a shadow of the subject. In the generating, the image processing apparatus generates a display image exhibiting the subject from a predetermined viewpoint, using the three-dimensional model reconstructed on the basis of the two-dimensional image data and the depth data.

According to the other aspect of the present technology, two-dimensional image data, depth data, and shadow information are received. The two-dimensional image data and the depth data are generated on the basis of a three-dimensional model generated from each of viewpoint images of a subject. The viewpoint images are captured through imaging from a plurality of viewpoints and subjected to a shadow removal process. The shadow information is information related to a shadow of the subject. A display image exhibiting the subject from a predetermined viewpoint is generated using the three-dimensional model reconstructed on the basis of the two-dimensional image data and the depth data.

### Effects of the Invention

The present technology enables transmission of a three-dimensional model of a subject and shadow information of the subject in a separate manner.

It should be noted that the above-described effects are not necessarily limitative. Any of the effects described in the present disclosure may be exerted.

### BRIEF DESCRIPTION OF DRAWINGS

FIG. 1 is a block diagram illustrating an example of a configuration of a free-viewpoint image transmission system according to an embodiment of the present technology.

FIG. 2 is a diagram explaining shadow processing.

FIG. 3 is a diagram illustrating an example of a texture-mapped three-dimensional model projected to projection space including a background different from that at the time of imaging.

FIG. 4 is a block diagram illustrating an example of a configuration of an encoding system and a decoding system.

FIG. 5 is a block diagram illustrating an example of a configuration of a three-dimensional data imaging device, a conversion device, and an encoding device included in the encoding system.

FIG. 6 is a block diagram illustrating an example of a configuration of an image processing unit included in the three-dimensional data imaging device.

FIG. 7 is a diagram illustrating an example of images that are used for a background subtraction process.

FIG. 8 is a diagram illustrating an example of images that are used for a shadow removal process.

FIG. 9 is a block diagram illustrating an example of a configuration of a conversion unit included in the conversion device.

FIG. 10 is a diagram illustrating an example of camera positions for virtual viewpoints.

FIG. 11 is a block diagram illustrating an example of a configuration of a decoding device, a conversion device, and a three-dimensional data display device included in the decoding system.

FIG. 12 is a block diagram illustrating an example of a configuration of a conversion unit included in the conversion device.

FIG. 13 is a diagram explaining a process of generating a three-dimensional model of projection space.

FIG. 14 is a flowchart explaining processes to be performed by the encoding system.

FIG. 15 is a flowchart explaining an imaging process at step S11 in FIG. 14.

FIG. 16 is a flowchart explaining a shadow removal process at step S56 in FIG. 15.

FIG. 17 is a flowchart explaining another example of the shadow removal process at step S56 in FIG. 15.

FIG. 18 is a flowchart explaining a conversion process at step S12 in FIG. 14.

FIG. 19 is a flowchart explaining an encoding process at step S13 in FIG. 14.

FIG. 20 is a flowchart explaining processes to be performed by the decoding system.

FIG. 21 is a flowchart explaining a decoding process at step S201 in FIG. 20.

FIG. 22 is a flowchart explaining a conversion process at step S202 in FIG. 20.

FIG. 23 is a block diagram illustrating an example of another configuration of the conversion unit of the conversion device included in the decoding system.

FIG. 24 is a flowchart explaining the conversion process to be performed by the conversion unit in FIG. 23.

FIG. 25 is a diagram illustrating an example of two types of areas of comparative darkness.

FIG. 26 is a diagram illustrating examples of effects that are produced by presence or absence of a shadow or a shade.

FIG. 27 is a block diagram illustrating an example of another configuration of the encoding system and the decoding system.

FIG. 28 is a block diagram illustrating an example of yet another configuration of the encoding system and the decoding system.

FIG. 29 is a block diagram illustrating an example of a configuration of a computer.

### MODES FOR CARRYING OUT THE INVENTION

The following describes embodiments of the present technology. The description is given in the following order.

### 1. First Embodiment (Configuration Example of Free-viewpoint Image Transmission System)

### 2. Configuration Examples of Devices in Encoding System

### 3. Configuration Examples of Devices in Decoding System

### 4. Operation Example of Encoding System

### 5. Operation Example of Decoding System

### 6. Modification Example of Decoding System

### 7. Second Embodiment (Another Configuration Example of Encoding System and Decoding System)

### 8. Third Embodiment (Another Configuration Example of Encoding System and Decoding System)

### 9. Example of Computer

### <<1. Configuration Example of Free-Viewpoint Image Transmission System>>

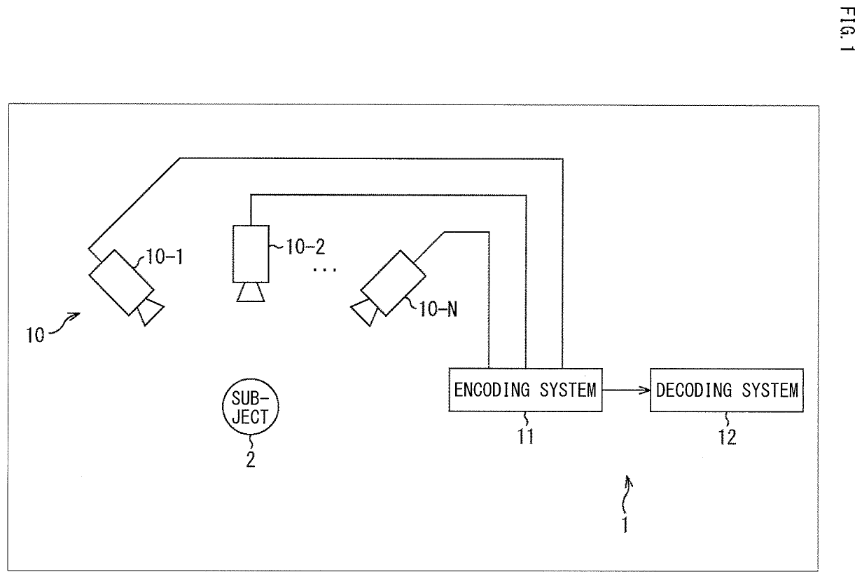

FIG. 1 is a block diagram illustrating an example of a configuration of a free-viewpoint image transmission system according to an embodiment of the present technology.

A free-viewpoint image transmission system 1 in FIG. 1 includes a decoding system 12 and an encoding system 11 including cameras 10-1 to 10-N.

Each of the cameras 10-1 to 10-N includes an imager and a rangefinder, and is disposed in imaging space in which a predetermined object is placed as a subject 2. Hereinafter, the cameras 10-1 to 10-N are collectively referred to as cameras 10 as appropriate in a case where it is not necessary to distinguish the cameras from one another.

The imager included in each of the cameras 10 performs imaging to capture two-dimensional image data of a moving image of the subject. The imager may capture a still image of the subject. The rangefinder includes components such as a ToF camera and an active sensor. The rangefinder generates depth image data (referred to below as depth data) representing a distance to the subject 2 from the same viewpoint as the viewpoint of the imager. The cameras 10 provide a plurality of pieces of two-dimensional image data representing a state of the subject 2 from respective viewpoints and a plurality of pieces of depth data from the respective viewpoints.

It should be noted that the pieces of depth data do not have to be from the same viewpoint, because the depth data is calculable from camera parameters. Furthermore, no existing camera is able to capture color image data and depth data from the same viewpoint at the same time.

The encoding system 11 performs a shadow removal process, which is a process of removing a shadow of the subject 2, on the pieces of captured two-dimensional image data from the respective viewpoints, and generates a three-dimensional model of the subject on the basis of the pieces of depth data and the pieces of shadow-removed two-dimensional image data from the respective viewpoints. The three-dimensional model generated herein is a three-dimensional model of the subject 2 in the imaging space.

Furthermore, the encoding system 11 converts the three-dimensional model to two-dimensional image data and depth data, and generates an encoded stream by encoding the converted data together with shadow information of the subject 2 obtained through the shadow removal process. The encoded stream for example includes pieces of two-dimensional image data and pieces of depth data corresponding to the plurality of viewpoints.

It should be noted that the encoded stream also includes camera parameters for virtual viewpoint position information, and the camera parameters for the virtual viewpoint position information include, as appropriate, viewpoints virtually set in space of the three-dimensional model as well as viewpoints which correspond to installation positions of the cameras 10 and from which the imaging, the capturing of the two-dimensional image data, and the like are actually performed.

The encoded stream generated by the encoding system 11 is transmitted to the decoding system 12 via a network or a predetermined transmission path such as a recording medium.

The decoding system 12 decodes the encoded stream supplied from the encoding system 11 and obtains the two-dimensional image data, the depth data, and the shadow information of the subject 2. The decoding system 12 generates (reconstructs) a three-dimensional model of the subject 2 on the basis of the two-dimensional image data and the depth data, and generates a display image on the basis of the three-dimensional model.

The decoding system 12 generates the display image by projecting the three-dimensional model generated on the basis of the encoded stream together with a three-dimensional model of projection space, which is virtual space.

Information related to the projection space may be transmitted from the encoding system 11. Furthermore, the shadow information of the subject is added to the three-dimensional model of the projection space as necessary, and the three-dimensional model of the projection space and the three-dimensional model of the subject are projected.

It should be noted that an example has been described in which the cameras in the free-viewpoint image transmission system 1 in FIG. 1 are provided with the rangefinders. However, the depth information is obtainable through triangulation using an RGB image, and therefore it is possible to perform the three-dimensional modeling of the subject without the rangefinders. It is possible to perform the three-dimensional modeling with imaging equipment including only a plurality of cameras, with imaging equipment including both a plurality of cameras and a plurality of rangefinders, or with a plurality of rangefinders only. A configuration in which the rangefinders are ToF cameras enables acquisition of an IR image, allowing the rangefinders to perform three-dimensional modeling only with a point cloud.

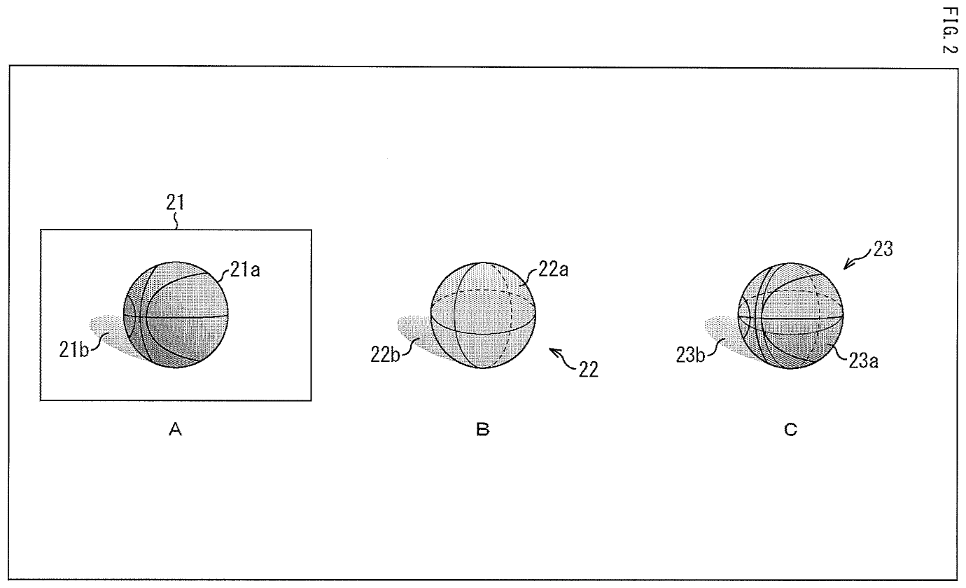

FIG. 2 is a diagram explaining shadow processing.

A of FIG. 2 is a diagram illustrating an image captured by a camera having a certain viewpoint. A camera image 21 in A of FIG. 2 exhibits a subject (a basketball in an example illustrated in A of FIG. 2) 21a and a shadow 21b thereof. It should be noted that image processing described here is different from processing to be performed in the free-viewpoint image transmission system 1 in FIG. 1.

B of FIG. 2 is a diagram illustrating a three-dimensional model 22 generated from the camera image 21. The three-dimensional model 22 in B of FIG. 2 includes a three-dimensional model 22a representing a shape of the subject 21a and a shadow 22b thereof.

C of FIG. 2 is a diagram illustrating a texture-mapped three-dimensional model 23. The three-dimensional model 23 includes a three-dimensional model 23a and a shadow 23b thereof. The three-dimensional model 23a is obtained by performing texture mapping on the three-dimensional model 22a.

The shadow as used here in the present technology means the shadow 22b of the three-dimensional model 22 generated from the camera image 21 or the shadow 23b of the texture-mapped three-dimensional model.

Existing three-dimensional modeling is image-based. That is, a shadow is also subjected to modeling and texture mapping, making it difficult to separate the shadow from the resulting three-dimensional model.

With the shadow 23b, the texture-mapped three-dimensional model 23 tends to look more natural. However, with the shadow 22b, the three-dimensional model 22 generated from the camera image 21 may look unnatural, and there is a demand to remove the shadow 22b.

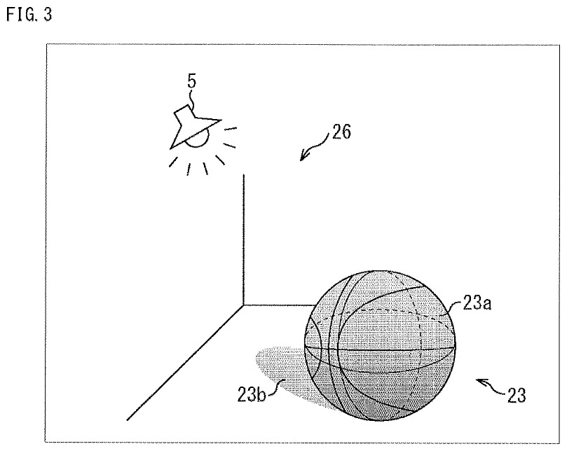

FIG. 3 is a diagram illustrating an example of the texture-mapped three-dimensional model 23 projected to projection space 26 including a background different from that at the time of the imaging.

In a case where an illuminator 25 is located in a position different from that at the time of the imaging in the projection space 26, a position of the shadow 23b of the texture-mapped three-dimensional model 23 may be unnatural due to being inconsistent with a direction of light from the illuminator 25 as illustrated in FIG. 3.

The free-viewpoint image transmission system 1 according to the present technology therefore performs the shadow removal process on the camera image and transmits the three-dimensional model and the shadow in a separate manner. It is therefore possible to select whether to add or remove the shadow to or from the three-dimensional model in the decoding system 12 at a displaying end, making the system convenient for users.

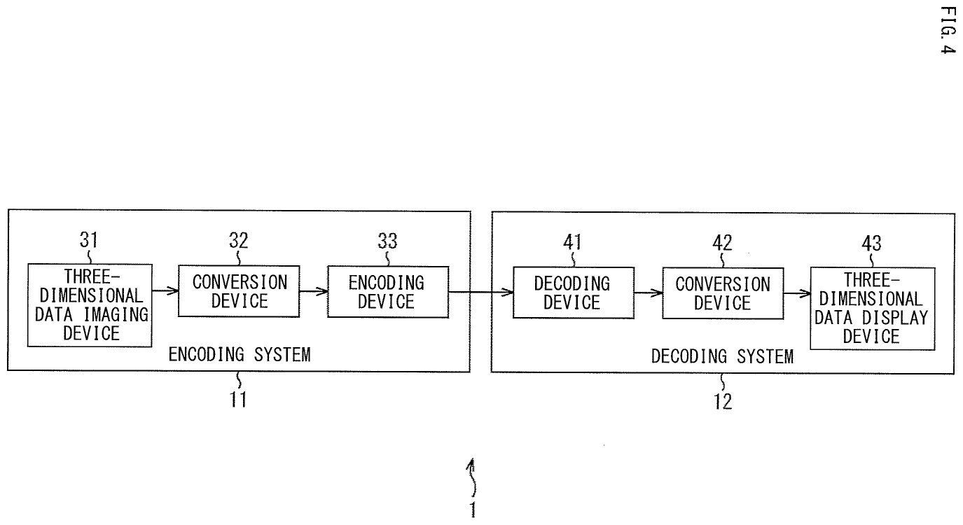

FIG. 4 is a block diagram illustrating an example of a configuration of the encoding system and the decoding system.

The encoding system 11 includes a three-dimensional data imaging device 31, a conversion device 32, and an encoding device 33.

The three-dimensional data imaging device 31 controls the cameras 10 to perform imaging of a subject. The three-dimensional data imaging device 31 performs the shadow removal process on pieces of two-dimensional image data from respective viewpoints and generates a three-dimensional model on the basis of the shadow-removed two-dimensional image data and depth data. The generation of the three-dimensional model also involves the use of camera parameters of each of the cameras 10.

The three-dimensional data imaging device 31 supplies, to the conversion device 32, the generated three-dimensional model together with the camera parameters and shadow maps being shadow information corresponding to camera positions at the time of the imaging.

The conversion device 32 determines camera positions from the three-dimensional model supplied from the three-dimensional data imaging device 31, and generates the camera parameters, the two-dimensional image data, and the depth data depending on the determined camera positions. The conversion device 32 generates shadow maps corresponding to camera positions for virtual viewpoints that are camera positions other than the camera positions at the time of the imaging. The conversion device 32 supplies the camera parameters, the two-dimensional image data, the depth data, and the shadow maps to the encoding device 33.

The encoding device 33 generates an encoded stream by encoding the camera parameters, the two-dimensional image data, the depth data, and the shadow maps supplied from the conversion device 32. The encoding device 33 transmits the generated encoded stream.

By contrast, the decoding system 12 includes a decoding device 41, a conversion device 42, and a three-dimensional data display device 43.

The decoding device 41 receives the encoded stream transmitted from the encoding device 33 and decodes the encoded stream in accordance with a scheme corresponding to an encoding scheme employed in the encoding device 33. Through the decoding, the decoding device 41 acquires the two-dimensional image data and the depth data from the plurality of viewpoints, and the shadow maps and the camera parameters, which are metadata. The decoding device 41 then supplies the acquired data to the conversion device 42.

The conversion device 42 performs the following process as a conversion process. That is, the conversion device 42 selects two-dimensional image data and depth data from a predetermined viewpoint on the basis of the meta data supplied from the decoding device 41 and a display image generation scheme employed in the decoding system 12. The conversion device 42 generates display image data by generating (reconstructing) a three-dimensional model on the basis of the selected two-dimensional image data and depth data from the predetermined viewpoint, and projecting the three-dimensional model. The generated display image data is supplied to the three-dimensional data display device 43.

The three-dimensional data display device 43 includes, for example, a two- or three-dimensional head mounted display, a two- or three-dimensional monitor, or a projector. The three-dimensional data display device 43 two- or three-dimensionally displays a display image on the basis of the display image data supplied from the conversion device 42.

### <<2. Configuration Examples of Devices in Encoding System>>

Now, a configuration of each of the devices in the encoding system 11 will be described.

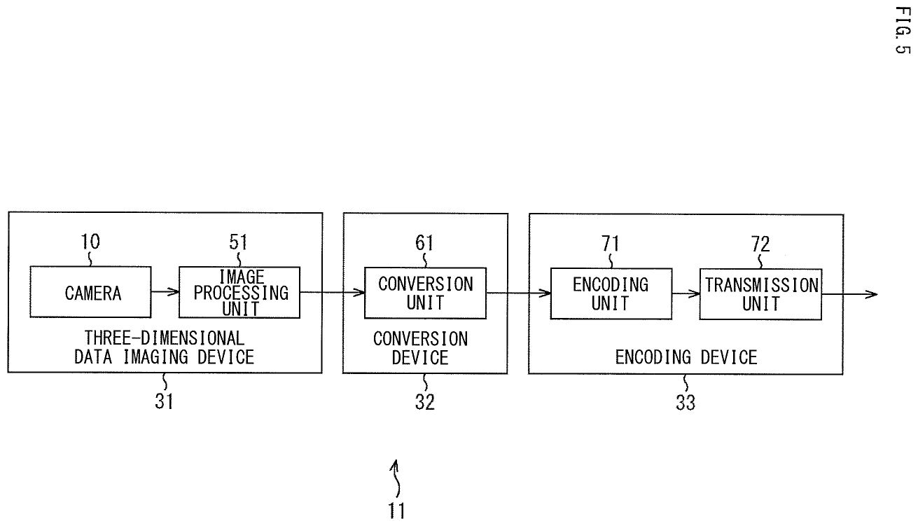

FIG. 5 is a block diagram illustrating an example of the configuration of the three-dimensional data imaging device 31, the conversion device 32, and the encoding device 33 included in the encoding system 11.

The three-dimensional data imaging device 31 includes the cameras 10 and an image processing unit 51.

The image processing unit 51 performs the shadow removal process on the pieces of two-dimensional image data from the respective viewpoints obtained from the respective cameras 10. After the shadow removal process, the image processing unit 51 performs modeling to create a mesh or a point cloud using the pieces of two-dimensional image data and the pieces of depth data from the respective viewpoints, and the camera parameters of each of the cameras 10.

The image processing unit 51 generates, as the three-dimensional model of the subject, information related to the created mesh and two-dimensional image (texture) data of the mesh, and supplies the three-dimensional model to the conversion device 32. The shadow maps, which are the information related to the removed shadow, are also supplied to the conversion device 32.

The conversion device 32 includes a conversion unit 61.

As described above regarding the conversion device 32, the conversion unit 61 determines the camera positions on the basis of the camera parameters of each of the cameras 10 and the three-dimensional model of the subject, and generates the camera parameters, the two-dimensional image data, and the depth data depending on the determined camera positions. At this time, the shadow maps, which are the shadow information, are also generated depending on the determined camera positions. The thus generated information is supplied to the encoding device 33.

The encoding device 33 includes an encoding unit 71 and a transmission unit 72.

The encoding unit 71 encodes the camera parameters, the two-dimensional image data, the depth data, and the shadow maps supplied from the conversion unit 61 to generate the encoded stream. The camera parameters and the shadow maps are encoded as metadata.

Projection space data, if any, is also supplied to the encoding unit 71 as metadata from an external device such as a computer, and encoded by the encoding unit 71. The projection space data is a three-dimensional model of the projection space, such as a room, and texture data thereof. The texture data includes image data of the room, image data of the background used in the imaging, or texture data forming a set with the three-dimensional model.

Encoding schemes such as an MVCD (Multiview and depth video coding) scheme, an AVC scheme, and a HEVC scheme may be employed. Regardless of whether the encoding scheme is the MVCD scheme or the encoding scheme is the AVC scheme or the HEVC scheme, the shadow maps may be encoded together with the two-dimensional image data and the depth data or may be encoded as metadata.

In a case where the encoding scheme is the MVCD scheme, the pieces of two-dimensional image data and the pieces of depth data from all of the viewpoints are encoded together. As a result, one encoded stream including the metadata, and the encoded data of the two-dimensional image data and the depth data is generated. In such a case, the camera parameters out of the metadata are stored in reference displays information SEI of the encoded stream. Furthermore, the depth data out of the metadata is stored in depth representation information SEI.

By contrast, in a case where the encoding scheme is the AVC scheme or the HEVC scheme, the pieces of depth data from the respective viewpoints and the pieces of two-dimensional image data from the respective viewpoints are encoded separately. As a result, an encoded stream corresponding to the viewpoints including the metadata and the pieces of two-dimensional image data from the respective viewpoints; and an encoded stream corresponding to the viewpoints including the metadata and the encoded data of the pieces of depth data from the respective viewpoints are generated. In such a case, the metadata is stored in, for example, User unregistered SEI of each of the encoded streams. Furthermore, the metadata includes information that associates the encoded stream with information such as the camera parameters.

It should be noted that the metadata does not have to include the information that associates the encoded stream with information such as the camera parameters. That is, each of the encoded streams may include only metadata corresponding to the encoded stream. The encoding unit 71 supplies, to the transmission unit 72, the encoded stream(s) obtained through the encoding in accordance with any of the above-described schemes.

The transmission unit 72 transmits, to the decoding system 12, the encoded stream supplied from the encoding unit 71. It should be noted that although the metadata herein is transmitted by being stored in the encoded stream, the metadata may be transmitted separately from the encoded stream.

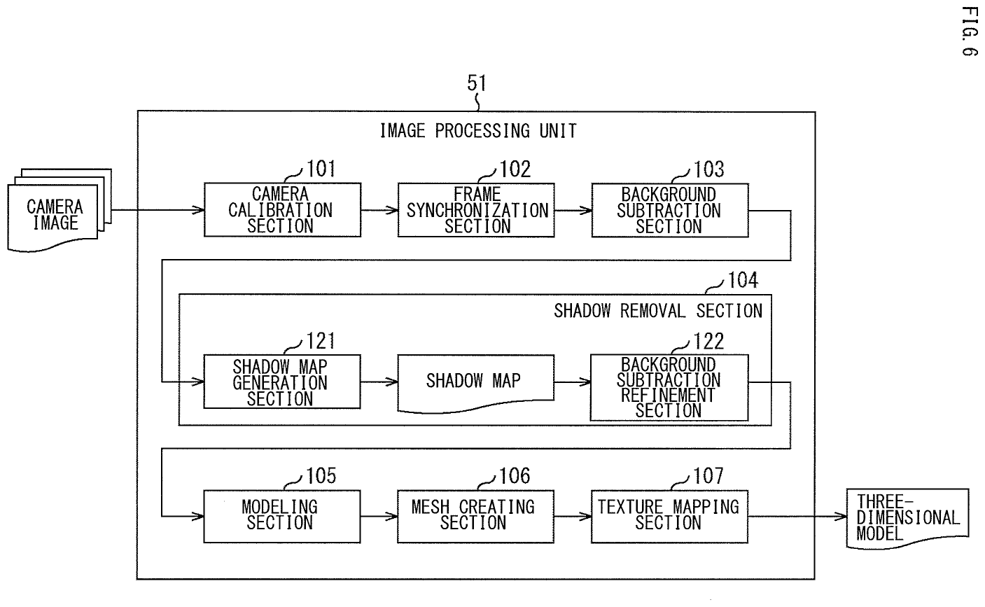

FIG. 6 is a block diagram illustrating an example of the configuration of the image processing unit 51 of the three-dimensional data imaging device 31.

The image processing unit 51 includes a camera calibration section 101, a frame synchronization section 102, a background subtraction section 103, a shadow removal section 104, a modeling section 105, a mesh creating section 106, and a texture mapping section 107.

The camera calibration section 101 performs calibration on the pieces of two-dimensional image data (camera images) supplied from the respective cameras 10 using the camera parameters. Examples of calibration methods include the Zhang method using a chessboard, a method in which parameters are determined by performing imaging of a three-dimensional object, and a method in which parameters are determined by obtaining a projected image using a projector.

The camera parameters for example include intrinsic parameters and extrinsic parameters. The intrinsic parameters are camera-specific parameters, and are camera lens distortion or image sensor and lens tilt (distortion coefficient), image center, and image (pixel) size. The extrinsic parameters indicate, in a case where there is a plurality of cameras, a positional relationship between the plurality of cameras, or indicate coordinates of lens center (translation) and a direction of lens optical axis (rotation) in a world coordinate system.

The camera calibration section 101 supplies the calibrated two-dimensional image data to the frame synchronization section 102. The camera parameters are supplied to the conversion unit 61 through a path, not illustrated.

The frame synchronization section 102 uses one of the cameras 10-1 to 10-N as a base camera and the others as reference cameras. The frame synchronization section 102 synchronizes frames of the two-dimensional image data of the reference cameras with a frame of the two-dimensional image data of the base camera. The frame synchronization section 102 supplies the two-dimensional image data subjected to the frame synchronization to the background subtraction section 103.

The background subtraction section 103 performs a background subtraction process on the two-dimensional image data and generates silhouette images, which are masks directed to extracting the subject (foreground).

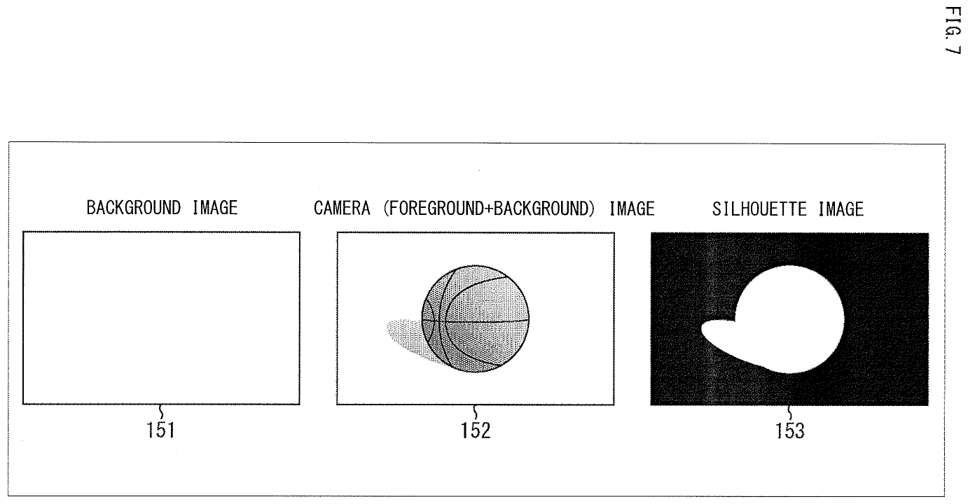

FIG. 7 is a diagram illustrating an example of images that are used for the background subtraction process.

As illustrated in FIG. 7, the background subtraction section 103 obtains a difference between a background image 151 that includes only a pre-acquired background and, as a process target, a camera image 152 that includes both a foreground region and a background region, thereby to acquire a binary silhouette image 153 in which a difference-containing region (foreground region) corresponds to 1. Pixel values are usually influenced by noise depending on the camera that has performed the imaging. It is therefore rare that pixel values of the background image 151 and pixel values of the camera image 152 fully match. The binary silhouette image 153 is therefore generated by using a threshold 0 and determining pixel values having a difference smaller than or equal to the threshold 0 to be those of the background and the other pixel values to be those of the foreground. The silhouette image 153 is supplied to the shadow removal section 104.

A background subtraction process such as background extraction by Deep learning (https://arxiv.org/pdf/1702.01731.pdf) using Convolutional Neural Network (CNN) has recently been proposed. A background subtraction process using the Deep learning and machine learning is also generally known.

The shadow removal section 104 includes a shadow map generation section 121 and a background subtraction refinement section 122.

Even after the camera image 152 has been masked with the silhouette image 153, the image of the subject is accompanied by an image of a shadow.

The shadow map generation section 121 therefore generates a shadow map in order to perform the shadow removal process on the image of the subject. The shadow map generation section 121 supplies the generated shadow map to the background subtraction refinement section 122.

The background subtraction refinement section 122 applies the shadow map to the silhouette image obtained in the background subtraction section 103 to generate a shadow-removed silhouette image.

Methods for the shadow removal process, represented by Shadow Optimization from Structured Deep Edge Detection, have been presented in CVPR 2015, and a predetermined one selected from among these methods is used. Alternatively, SLIC (Simple Linear Iterative Clustering) may be used for the shadow removal process, or a shadow-less two-dimensional image may be generated using a depth image obtained through an active sensor.

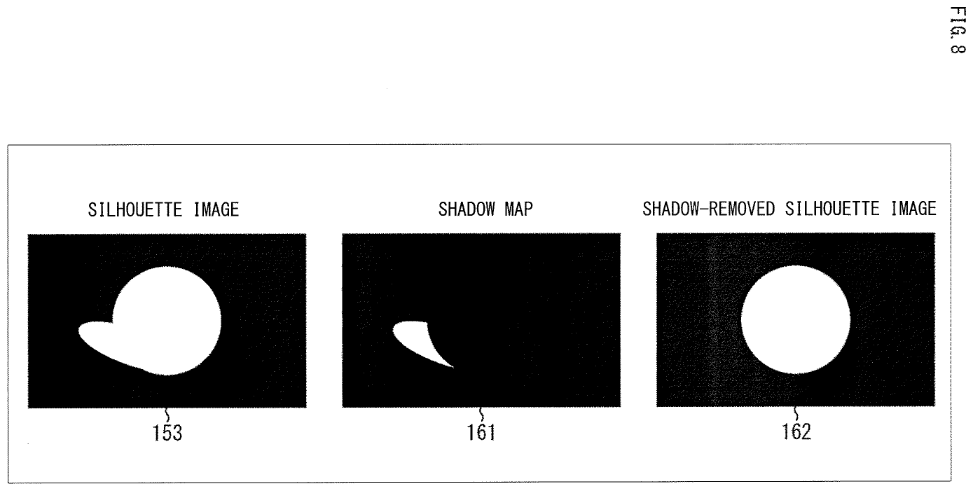

FIG. 8 is a diagram illustrating an example of images that are used for the shadow removal process. The following describes the shadow removal process according to SLIC in which an image is divided into super pixels to determine a region with reference to FIG. 8. The description also refers to FIG. 7 as appropriate.

The shadow map generation section 121 divides the camera image 152 (FIG. 7) into super pixels. The shadow map generation section 121 identifies similarities between a portion of the super pixels that has been excluded through the background subtraction (super pixels corresponding to a black portion of the silhouette image 153) and a portion of the super pixels that has remained as the shadow (super pixels corresponding to a white portion of the silhouette image 153).

An example will be given on the assumption that super pixels A have been determined to be 0 (black) in the background subtraction, which is correct. Super pixels B have been determined to be 1 (white) in the background subtraction, which is incorrect. Super pixels C have been determined to be 1 (white) in the background subtraction, which is correct. The similarities are re-identified in order to correct the incorrect determination for the super pixels B. As a result, the similarity between the super pixels A and the super pixels B is found to be higher than the similarity between the super pixels B and the super pixels C, confirming the incorrect determination. The silhouette image 153 is corrected on the basis of the confirmation.

The shadow map generation section 121 uses, as a shadow region, a region (of the super pixels) that has remained in the silhouette image 153 (the subject or the shadow) and that has been determined to be a floor through the SLIC to generate a shadow map 161 as illustrated in FIG. 8.

The type of the shadow map 161 may be a 0,1 (binary) shadow map or a color shadow map.

In the 0,1 shadow map, the shadow region is represented as 1, and a non-shadow background region is represented as 0.

In the color shadow map, the shadow map is exhibited by four RGBA channels in addition to the above-described 0,1 shadow map. The RGB represent colors of the shadow. The Alpha channel may represent transparency. The 0,1 shadow map may be added to the Alpha channel. Only the three RGB channels may be used.

Furthermore, it is not necessary to exhibit the shadow region very clearly, and therefore the shadow map 161 may be low-resolution.

The background subtraction refinement section 122 performs background subtraction refinement. That is, the background subtraction refinement section 122 applies the shadow map 161 to the silhouette image 153 to shape the silhouette image 153, generating a shadow-removed silhouette image 162.

Furthermore, it is also possible to perform the shadow removal process by introducing an active sensor such as a ToF camera, a LIDAR, and a laser, and using a depth image obtained through the active sensor. It should be noted that according to this method, the shadow is not imaged, and therefore a shadow map is not generated.

The shadow removal section 104 generates a depth difference silhouette image depending on a depth difference using a background depth image and a foreground background depth image. The background depth image represents a distance from the camera position to the background, and the foreground background depth image represents a distance from the camera position to the foreground and a distance from the camera position to the background. Furthermore, the shadow removal section 104 uses the background depth image and the foreground background depth image to obtain, from the depth images, a depth distance to the foreground. The shadow removal section 104 then generates an effective distance mask indicating an effective distance by defining pixels of the depth distance as 1 and pixels of the other distances as 0.

The shadow removal section 104 generates a shadow-less silhouette image by masking the depth difference silhouette image with the effective distance mask. That is, a silhouette image equivalent to the shadow-removed silhouette image 162 is generated.

Referring back to FIG. 6, the modeling section 105 performs modelling by, for example, visual hull using the pieces of two-dimensional image data and the pieces of depth data from the respective viewpoints, the shadow-removed silhouette images, and the camera parameters. The modeling section 105 back-projects each of the silhouette images to the original three-dimensional space and obtains an intersection (a visual hull) of visual cones.

The mesh creating section 106 creates a mesh with respect to the visual hull obtained by the modeling section 105.

The texture mapping section 107 generates, as a texture-mapped three-dimensional model of the subject, two-dimensional image data of the created mesh and geometry indicating three-dimensional positions of vertices forming the mesh and a polygon defined by the vertices. The texture mapping section 107 then supplies the generated texture-mapped three-dimensional model to the conversion unit 61.

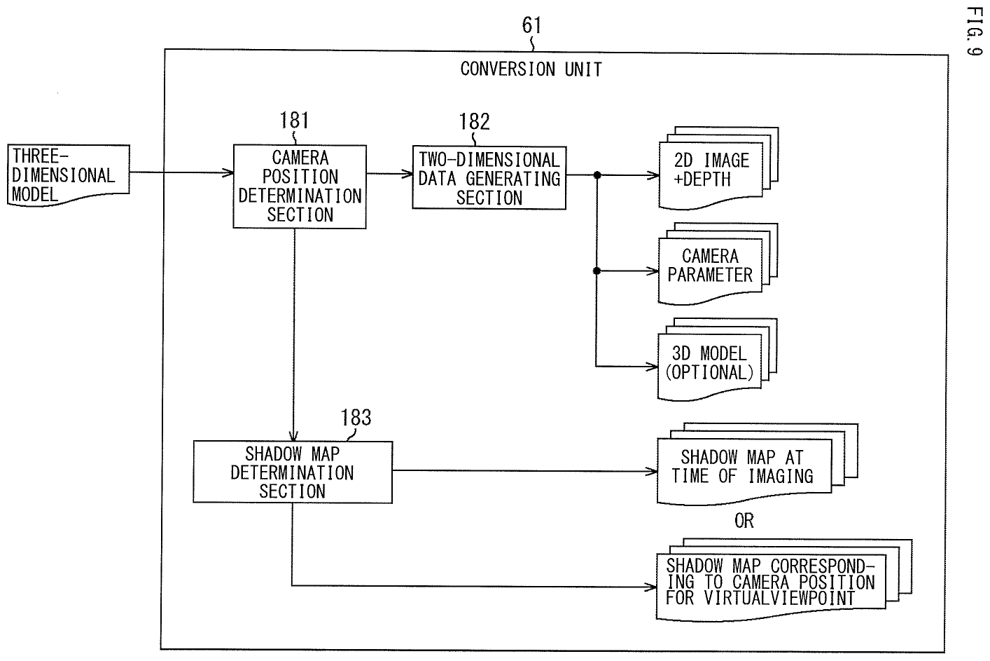

FIG. 9 is a block diagram illustrating an example of the configuration of the conversion unit 61 of the conversion device 32.

The conversion unit 61 includes a camera position determination section 181, a two-dimensional data generating section 182, and a shadow map determination section 183. The three-dimensional model supplied from the image processing unit 51 is inputted to the camera position determination section 181.

The camera position determination section 181 determines camera positions for a plurality of viewpoints in accordance with a predetermined display image generation scheme and camera parameters for the camera positions. The camera position determination section 181 then supplies information representing the camera positions and the camera parameters to the two-dimensional data generating section 182 and the shadow map determination section 183.

The two-dimensional data generating section 182 performs perspective projection of a three-dimensional object corresponding to the three-dimensional model for each of the viewpoints on the basis of the camera parameters corresponding to the plurality of viewpoints supplied from the camera position determination section 181.

Specifically, a relationship between a matrix m′ corresponding to two-dimensional positions of respective pixels and a matrix M corresponding to three-dimensional coordinates of the world coordinate system is represented by the following expression (1) using intrinsic camera parameters A and extrinsic camera parameters R|t.

[Math. 1]

sm′=A[R|t]M (1)

More specifically, the expression (1) is represented by the following expression (2).

$$[ Math . 2 ]$$

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad ( 2 )$$

In the expression (2), (u, v) represent two-dimensional coordinates on the image, and fx, fy represent a focal length. Furthermore, Cx, Cy represent a principal point, r11 to r13, r21 to r23, r31 to r33, and t1 to t3 represent parameters, and (X, Y, Z) represent three-dimensional coordinates of the world coordinate system.

Thus, the two-dimensional data generating section 182 determines three-dimensional coordinates corresponding to two-dimensional coordinates of each of pixels in accordance with the above-described expressions (1) and (2) using the camera parameters.

The two-dimensional data generating section 182 then takes, for each of the viewpoints, the two-dimensional image data of the three-dimensional coordinates corresponding to the two-dimensional coordinates of each of the pixels of the three-dimensional model as the two-dimensional image data of each of the pixels. That is, the two-dimensional data generating section 182 uses each of the pixels of the three-dimensional model as a pixel in a corresponding position on a two-dimensional image, thereby to generate the two-dimensional image data that associates the two-dimensional coordinates of each of the pixels with the image data.

Furthermore, the two-dimensional data generating section 182 determines, for each of the viewpoints, the depth of each of the pixels on the basis of the three-dimensional coordinates corresponding to the two-dimensional coordinates of each of the pixels of the three-dimensional model, thereby to generate the depth data that associates the two-dimensional coordinates of each of the pixels with the depth. That is, the two-dimensional data generating section 182 uses each of the pixels of the three-dimensional model as a pixel in a corresponding position on the two-dimensional image, thereby to generate the depth data that associates the two-dimensional coordinates of each of the pixels with the depth. The depth is for example represented as an inverse 1/z of a position z of the subject in a depth direction. The two-dimensional data generating section 182 supplies the pieces of two-dimensional image data and the pieces of depth data from the respective viewpoints to the encoding unit 71.

The two-dimensional data generating section 182 extracts three-dimensional occlusion data from the three-dimensional model supplied from the image processing unit 51 on the basis of the camera parameters supplied from the camera position determination section 181. The two-dimensional data generating section 182 then supplies the three-dimensional occlusion data to the encoding unit 71 as an optional three-dimensional model.

The shadow map determination section 183 determines shadow maps corresponding to the camera positions determined by the camera position determination section 181.

In a case where the camera positions determined by the camera position determination section 181 are the same as the camera positions at the time of the imaging, the shadow map determination section 183 supplies, to the encoding unit 71, the shadow maps corresponding to the camera positions at the time of the imaging as the shadow maps at the time of the imaging.

In a case where the camera positions determined by the camera position determination section 181 are not the same as the camera positions at the time of the imaging, the shadow map determination section 183 functions as an interpolated shadow map generation section and generates shadow maps corresponding to camera positions for virtual viewpoints. That is, the shadow map determination section 183 estimates the camera positions for the virtual viewpoints through viewpoint interpolation and generates the shadow maps by setting shadows corresponding to the camera positions for the virtual viewpoints.

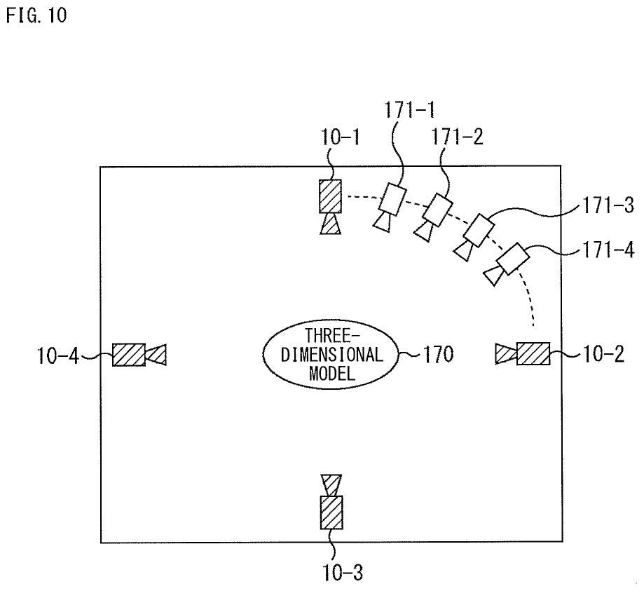

FIG. 10 is a diagram illustrating an example of the camera positions for the virtual viewpoints.

FIG. 10 illustrates the positions of the cameras 10-1 to 10-4, which represent the cameras used for the imaging, centered around a position of a three-dimensional model 170. FIG. 10 also illustrates camera positions 171-1 to 171-4 for the virtual viewpoints between the position of the camera 10-1 and the position of the camera 10-2. Such camera positions 171-1 to 171-4 for the virtual viewpoints are determined as appropriate in the camera position determination section 181.

It is possible to define the camera positions 171-1 to 171-4 and generate virtual viewpoint images, which are images from the camera positions for the virtual viewpoints, through viewpoint interpolation as long as the position of the three-dimensional model 170 is known. In such a case, the virtual viewpoint images are generated through viewpoint interpolation on the basis of information captured by the actual cameras 10 using the camera positions 171-1 to 171-4 for the virtual viewpoints, which are ideally set between the positions of the actual cameras 10 (it is possible to set the camera positions 171-1 to 171-4 to any other locations, but doing so may cause occlusion).

Although FIG. 10 illustrates the camera positions 171-1 to 171-4 for the virtual viewpoints only between the position of the camera 10-1 and the position of the camera 10-2, it is possible to freely determine the number and locations of camera positions 171. For example, a camera position 171-N for a virtual viewpoint may be set between the camera 10-2 and the camera 10-3, between the camera 10-3 and the camera 10-4, or between the camera 10-4 and the camera 10-1.

The shadow map determination section 183 generates the shadow maps as described above on the basis of the virtual viewpoint images from the thus set virtual viewpoints and supplies the shadow maps to the encoding unit 71.

### <<3. Configuration Examples of Devices in Decoding System>>

Now, a configuration of each of the devices in the decoding system 12 will be described.

FIG. 11 is a block diagram illustrating an example of the configuration of the decoding device 41, the conversion device 42, and the three-dimensional data display device 43 included in the decoding system 12.

The decoding device 41 includes a reception unit 201 and a decoding unit 202.

The reception unit 201 receives the encoded stream transmitted from the encoding system 11 and supplies the encoded stream to the decoding unit 202.

The decoding unit 202 decodes the encoded stream received by the reception unit 201 in accordance with a scheme corresponding to the encoding scheme employed in the encoding device 33. Through the decoding, the decoding unit 202 acquires the two-dimensional image data and the depth data from the plurality of viewpoints, and the shadow maps and the camera parameters, which are metadata. The decoding unit 202 then supplies the acquired data to the conversion device 42. In a case where there is encoded projection space data, as described above, this data is also decoded.

The conversion device 42 includes a conversion unit 203. As described above regarding the conversion device 42, the conversion unit 203 generates display image data by generating (reconstructing) a three-dimensional model on the basis of selected two-dimensional image data from a predetermined viewpoint or on the basis of selected two-dimensional image data and depth data from the predetermined viewpoint, and projecting the three-dimensional model. The generated display image data is supplied to the three-dimensional data display device 43.

The three-dimensional data display device 43 includes a display unit 204. As described above regarding the three-dimensional data display device 43, the display unit 204 includes, for example, a two-dimensional head mounted display, a two-dimensional monitor, a three-dimensional head mounted display, a three-dimensional monitor, or a projector. The display unit 204 two- or three-dimensionally displays the display image on the basis of the display image data supplied from the conversion unit 203.

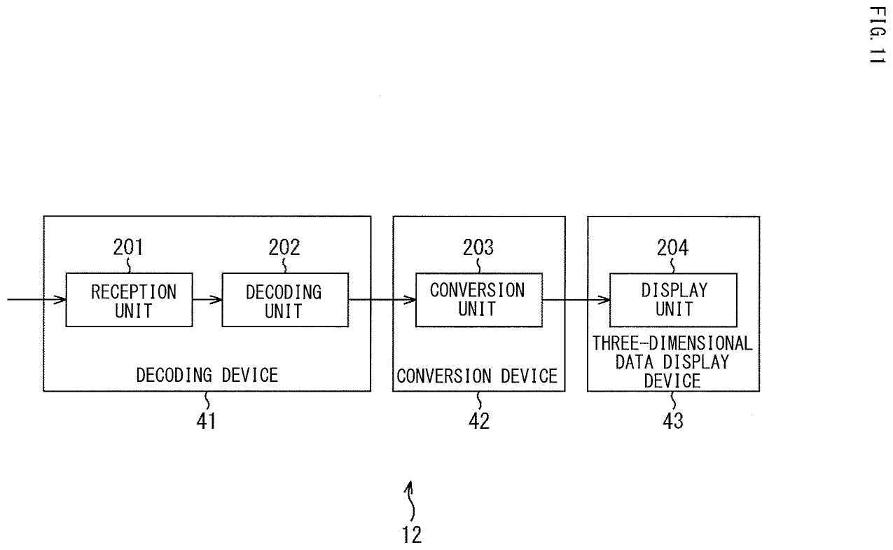

FIG. 12 is a block diagram illustrating an example of the configuration of the conversion unit 203 of the conversion device 42. FIG. 12 illustrates an example of the configuration in a case where the projection space to which the three-dimensional model is projected is the same as that at the time of the imaging, which in other words is a case where the projection space data transmitted from the encoding system 11 is used.

The conversion unit 203 includes a modeling section 221, a projection space model generation section 222, and a projection section 223. The camera parameters, the two-dimensional image data, and the depth data from the plurality of viewpoints supplied from the decoding unit 202 are inputted to the modeling section 221. Furthermore, the projection space data and the shadow maps supplied from the decoding unit 202 are inputted to the projection space model generation section 222.

The modeling section 221 selects camera parameters, two-dimensional image data, and depth data from the predetermined viewpoint out of the camera parameters, the two-dimensional image data, and the depth data from the plurality of viewpoints supplied from the decoding unit 202. The modeling section 221 generates (reconstructs) the three-dimensional model of the subject by performing modeling by, for example, visual hull using the camera parameters, the two-dimensional image data, and the depth data from the predetermined viewpoint. The generated three-dimensional model of the subject is supplied to the projection section 223.

As described above regarding the encoding end, the projection space model generation section 222 generates a three-dimensional model of the projection space using the projection space data and a shadow map supplied from the decoding unit 202. The projection space model generation section 222 then supplies the three-dimensional model of the projection space to the projection section 223.

The projection space data is the three-dimensional model of the projection space, such as a room, and texture data thereof. The texture data includes image data of the room, image data of the background used in the imaging, or texture data forming a set with the three-dimensional model.

The projection space data is not limited to being supplied from the encoding system 11 and may be data including a three-dimensional model of any space, such as outer space, a city, and game space, and texture data thereof set at the decoding system 12.

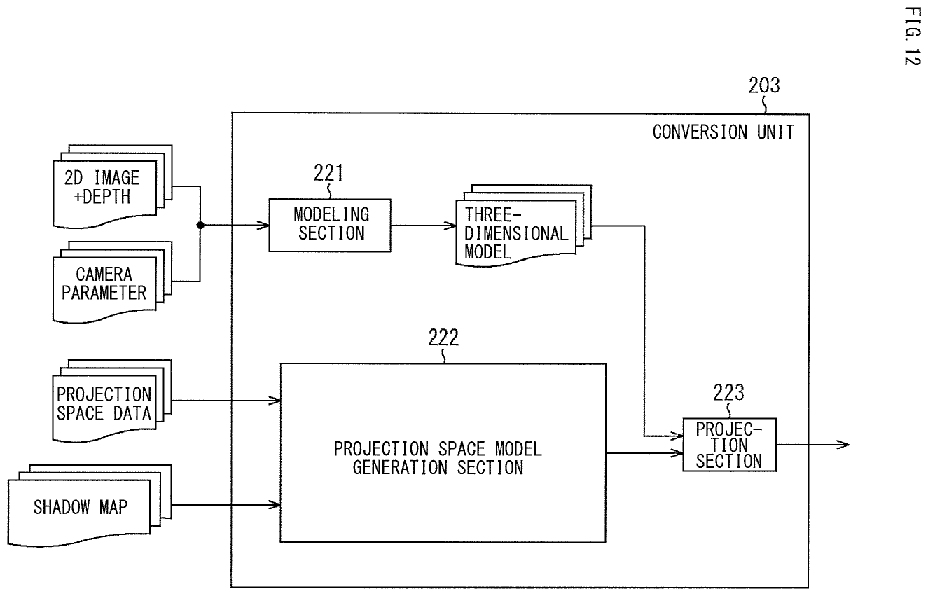

FIG. 13 is a diagram explaining a process of generating a three-dimensional model of projection space.

The projection space model generation section 222 generates a three-dimensional model 242 as illustrated at the middle of FIG. 13 by performing texture mapping on a three-dimensional model of desired projection space using projection space data. The projection space model generation section 222 also generates a three-dimensional model 243 of the projection space with a shadow 243a added thereto as illustrated at the right end of FIG. 13 by adding an image of a shadow generated on the basis of a shadow map 241 as illustrated at the left end of FIG. 13 to the three-dimensional model 242.

The three-dimensional model of the projection space may be manually generated by a user or may be downloaded. Alternatively, the three-dimensional model of the projection space may be automatically generated from a design, for example.

Furthermore, the texture mapping may also be performed manually, or textures may be automatically applied on the basis of the three-dimensional model. A three-dimensional model and textures integrated may be used unprocessed.

In a case where imaging is performed with a smaller number of cameras, background image data at the time of the imaging lacks data corresponding to three-dimensional model space, and only partial texture mapping is possible. In a case where imaging is performed with a larger number of cameras, background image data at the time of the imaging tends to cover the three-dimensional model space, and texture mapping based on depth estimation using triangulation is possible. In a case where background image data at the time of the imaging is sufficient, therefore, texture mapping may be performed using the background image data. In such a case, texture mapping may be performed after shadow information has been added to texture data from a shadow map.

The projection section 223 performs perspective projection of a three-dimensional object corresponding to the three-dimensional model of the projection space and the three-dimensional model of the subject. The projection section 223 uses each of the pixels of the three-dimensional model as a pixel in a corresponding position on a two-dimensional image, thereby to generate two-dimensional image data that associates two-dimensional coordinates of each of the pixels with the image data.

The generated two-dimensional image data is supplied to the display unit 204 as display image data. The display unit 204 displays a display image corresponding to the display image data.

### <<4. Operation Example of Encoding System>>

Now, operation of each of the devices having the above-described configurations will be described.

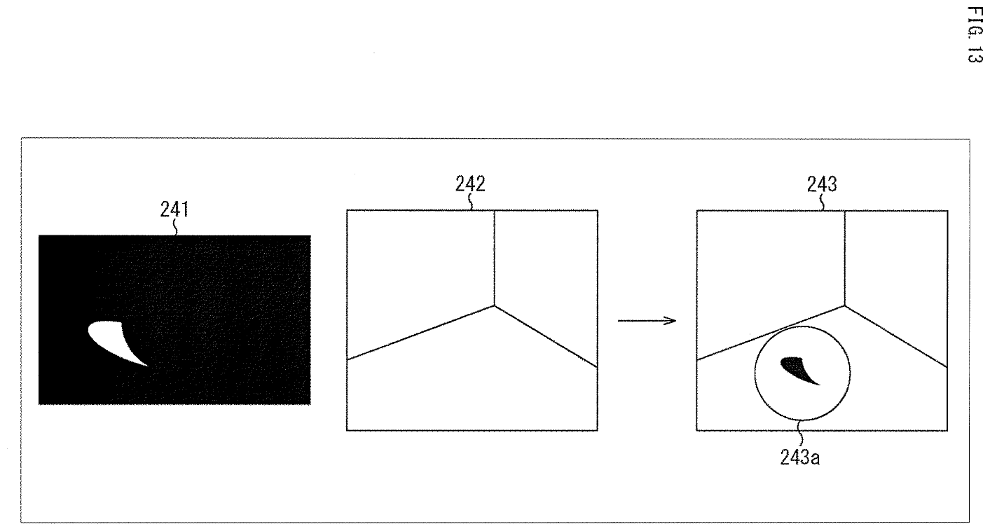

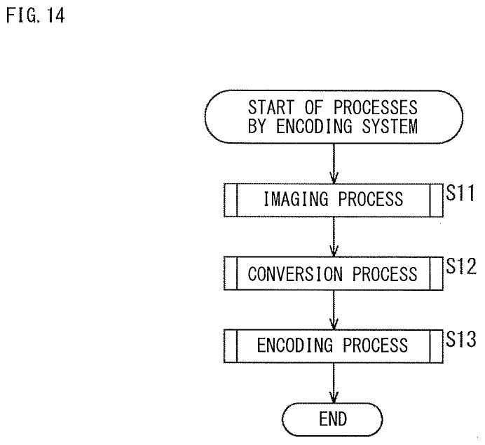

First, processes to be performed by the encoding system 11 will be described with reference to a flowchart in FIG. 14.

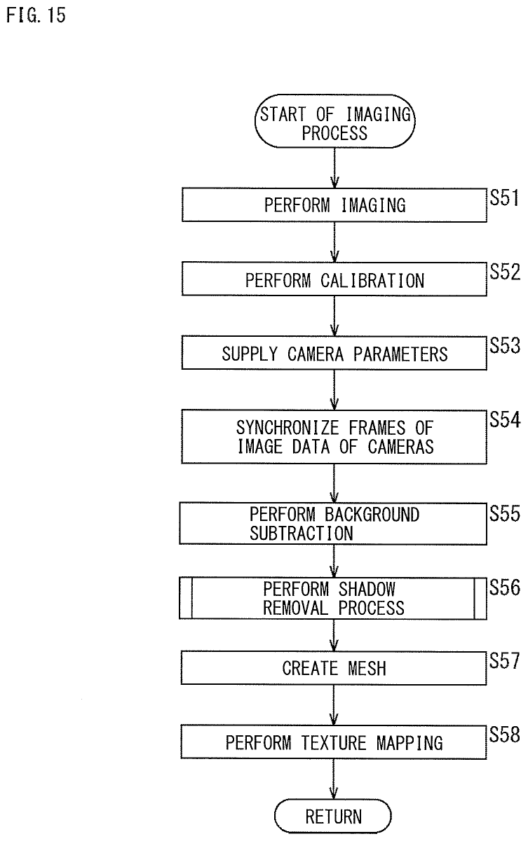

At step S11, the three-dimensional data imaging device 31 performs an imaging process on a subject with the cameras 10 mounted therein. This imaging process will be described below with reference to a flowchart in FIG. 15.

At step S11, the shadow removal process is performed on captured two-dimensional image data from viewpoints of the cameras 10, and a three-dimensional model of the subject is generated from the shadow-removed two-dimensional image data and depth data from the viewpoints of the cameras 10. The generated three-dimensional model is supplied to the conversion device 32.

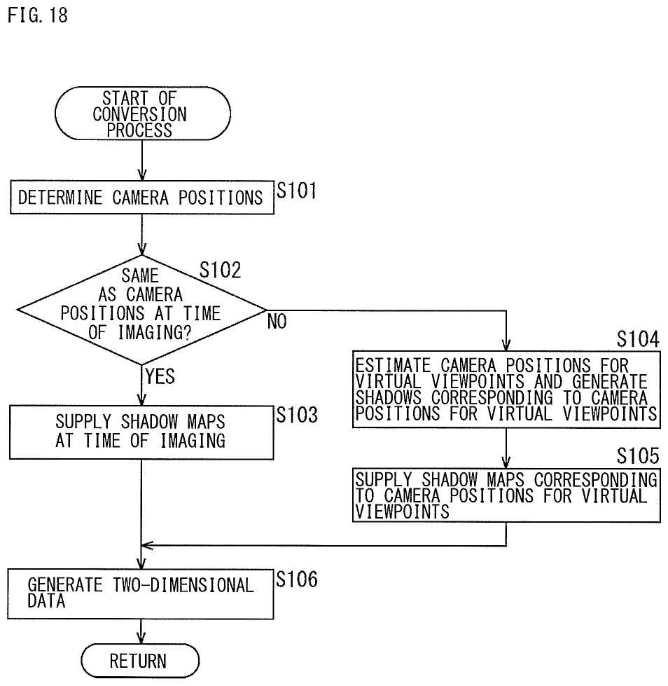

At step S12, the conversion device 32 performs a conversion process. This conversion process will be described below with reference to a flowchart in FIG. 18.

At step S12, camera positions are determined on the basis of the three-dimensional model of the subject, and camera parameters, two-dimensional image data, and depth data are generated depending on the determined camera positions. That is, through the conversion process, the three-dimensional model of the subject is converted to the two-dimensional image data and the depth data.

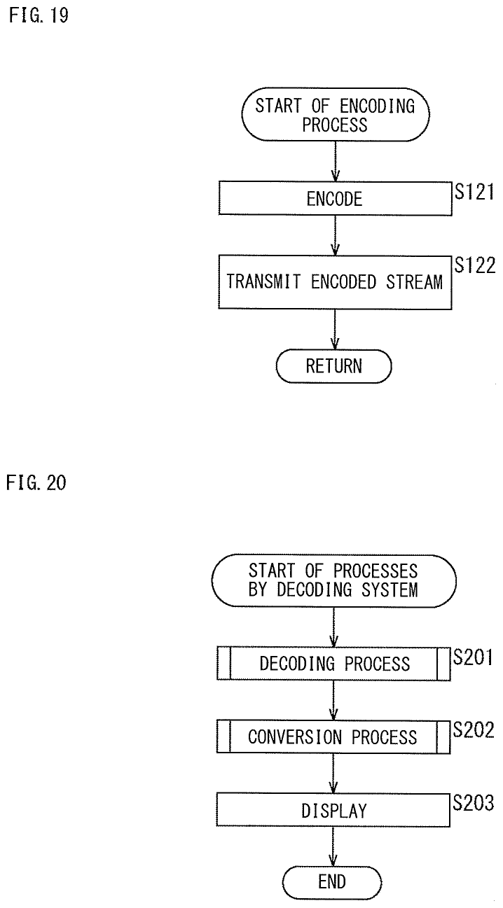

At step S13, the encoding device 33 performs an encoding process. This encoding process will be described below with reference to a flowchart in FIG. 19.

At step S13, the camera parameters, the two-dimensional image data, the depth data, and shadow maps supplied from the conversion device 32 are encoded and transmitted to the decoding system 12.

Next, the imaging process at step S11 in FIG. 14 will be described with reference to the flowchart in FIG. 15.

At step S51, the cameras 10 perform imaging of the subject. The imager of each of the cameras 10 captures two-dimensional image data of a moving image of the subject. The rangefinder of each of the cameras 10 generates depth data from the same viewpoint as the viewpoint of the camera 10. The two-dimensional image data and the depth data are supplied to the camera calibration section 101.

At step S52, the camera calibration section 101 performs calibration on the two-dimensional image data supplied from each of the cameras 10 using camera parameters. The calibrated two-dimensional image data is supplied to the frame synchronization section 102.

At step S53, the camera calibration section 101 supplies the camera parameters to the conversion unit 61 of the conversion device 32.

At step S54, the frame synchronization section 102 uses one of the cameras 10-1 to 10-N as a base camera and the others as reference cameras to synchronize frames of the two-dimensional image data of the reference cameras with a frame of the two-dimensional image data of the base camera. The synchronized frames of the two-dimensional images are supplied to the background subtraction section 103.

At step S55, the background subtraction section 103 performs a background subtraction process on the two-dimensional image data. That is, from each of camera images including foreground and background images, the background image is subtracted to generate a silhouette image directed to extracting the subject (foreground).

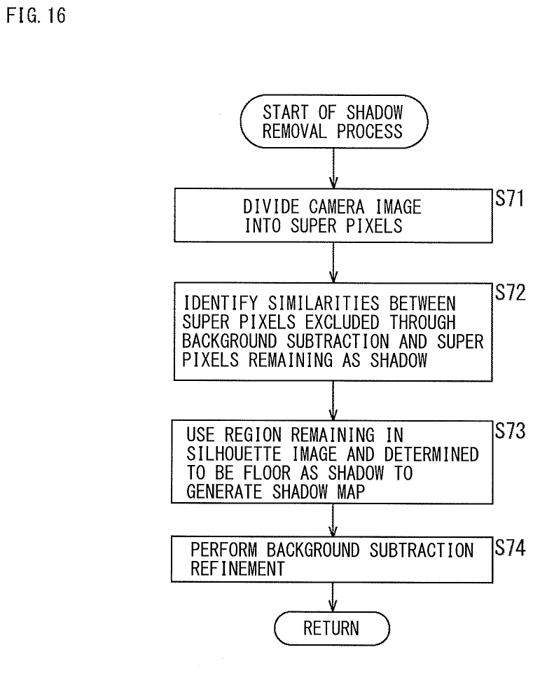

At step S56, the shadow removal section 104 performs the shadow removal process. This shadow removal process will be described below with reference to a flowchart in FIG. 16.

At step S56, shadow maps are generated, and the generated shadow maps are applied to the silhouette images to generate shadow-removed silhouette images.

At step S57, the modeling section 105 and the mesh creating section 106 create a mesh. The modeling section 105 performs modelling by, for example, visual hull using the pieces of two-dimensional image data and the pieces of depth data from the viewpoints of the respective cameras 10, the shadow-removed silhouette images, and the camera parameters to obtain a visual hull. The mesh creating section 106 creates a mesh with respect to the visual hull supplied from the modeling section 105.

At step S58, the texture mapping section 107 generates, as a texture-mapped three-dimensional model of the subject, two-dimensional image data of the created mesh and geometry indicating three-dimensional positions of vertices forming the mesh and a polygon defined by the vertices. The texture mapping section 107 then supplies the texture-mapped three-dimensional model to the conversion unit 61.

Next, the shadow removal process at step S56 in FIG. 15 will be described with reference to the flowchart in FIG. 16.

At step S71, the shadow map generation section 121 of the shadow removal section 104 divides the camera image 152 (FIG. 7) into super pixels.

At step S72, the shadow map generation section 121 identifies similarities between a portion of the super pixels, obtained by the division, that has been excluded through the background subtraction and a portion of the super pixels that has remained as the shadow.

At step S73, the shadow map generation section 121 uses, as a shadow, a region that has remained in the silhouette image 153 and that has been determined to be the floor through the SLIC to generate the shadow map 161 (FIG. 8).

At step S74, the background subtraction refinement section 122 performs background subtraction refinement and applies the shadow map 161 to the silhouette image 153. This shapes the silhouette image 153, generating the shadow-removed silhouette image 162.

The background subtraction refinement section 122 masks the camera image 152 with the shadow-removed silhouette image 162. This generates a shadow-removed image of the subject.

The method for the shadow removal process described above with reference to FIG. 16 is merely an example, and other methods may be employed. For example, the shadow removal process may be performed by employing a method described below.

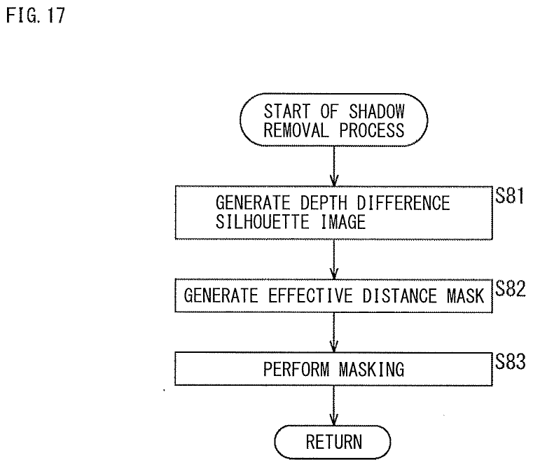

The following describes another example of the shadow removal process at step S56 in FIG. 15 with reference to a flowchart in FIG. 17. It should be noted that this process is an example of a case where the shadow removal process is performed by introducing an active sensor such as a ToF camera, a LIDAR, and a laser, and using a depth image obtained through the active sensor.

At step S81, the shadow removal section 104 generates a depth difference silhouette image using a background depth image and a foreground background depth image.

At step S82, the shadow removal section 104 generates an effective distance mask using the background depth image and the foreground background depth image.

At step S83, the shadow removal section 104 generates a shadow-less silhouette image by masking the depth difference silhouette image with the effective distance mask. That is, the shadow-removed silhouette image 162 is generated.

Next, the conversion process at step S12 in FIG. 14 will be described with reference to the flowchart in FIG. 18. The image processing unit 51 supplies the three-dimensional model to the camera position determination section 181.

At step S101, the camera position determination section 181 determines camera positions for a plurality of viewpoints in accordance with a predetermined display image generation scheme and camera parameters for the camera positions. The camera parameters are supplied to the two-dimensional data generating section 182 and the shadow map determination section 183.

At step S102, the shadow map determination section 183 determines whether or not the camera positions are the same as the camera positions at the time of the imaging. In a case where it is determined at step S102 that the camera positions are the same as the camera positions at the time of the imaging, the process advances to step S103.

At step S103, the shadow map determination section 183 supplies, to the encoding device 33, the shadow maps at the time of the imaging as the shadow maps corresponding to the camera positions at the time of the imaging.

In a case where it is determined at step S102 that the camera positions are not the same as the camera positions at the time of the imaging, the process advances to step S104.

At step S104, the shadow map determination section 183 estimates camera positions for virtual viewpoints through viewpoint interpolation and generates shadows corresponding to the camera positions for the virtual viewpoints.

At step S105, the shadow map determination section 183 supplies, to the encoding device 33, shadow maps corresponding to the camera positions for the virtual viewpoints, which are obtained from the shadows corresponding to the camera positions for the virtual viewpoints.

At step S106, the two-dimensional data generating section 182 performs perspective projection of a three-dimensional object corresponding to the three-dimensional model for each of the viewpoints on the basis of the camera parameters corresponding to the plurality of viewpoints supplied from the camera position determination section 181. The two-dimensional data generating section 182 then generates two-dimensional data (two-dimensional image data and depth data) as described above.

The two-dimensional image data and the depth data generated as described above are supplied to the encoding unit 71. The camera parameters and the shadow maps are also supplied to the encoding unit 71.

Next, the encoding process at step S13 in FIG. 14 will be described with reference to the flowchart in FIG. 19.

At step S121, the encoding unit 71 generates an encoded stream by encoding the camera parameters, the two-dimensional image data, the depth data, and the shadow maps supplied from the conversion unit 61. The camera parameters and the shadow maps are encoded as metadata.

Three-dimensional data such as three-dimensional occlusion data, if any, is encoded together with the two-dimensional image data and the depth data. Projection space data, if any, is also supplied to the encoding unit 71 as metadata from, for example, an external device such as a computer, and encoded by the encoding unit 71.

The encoding unit 71 supplies the encoded stream to the transmission unit 72.

At step S122, the transmission unit 72 transmits, to the decoding system 12, the encoded stream supplied from the encoding unit 71.

### <<5. Operation Example of Decoding System>>

Next, processes to be performed by the decoding system 12 will be described with reference to a flowchart in FIG. 20.

At step S201, the decoding device 41 receives the encoded stream and decodes the encoded stream in accordance with a scheme corresponding to an encoding scheme employed in the encoding device 33. The decoding process will be described below in detail with reference to a flowchart in FIG. 21.

As a result, the decoding device 41 acquires the two-dimensional image data and the depth data from the plurality of viewpoints, and the shadow maps and the camera parameters, which are metadata. The decoding device 41 then supplies the acquired data to the conversion device 42.

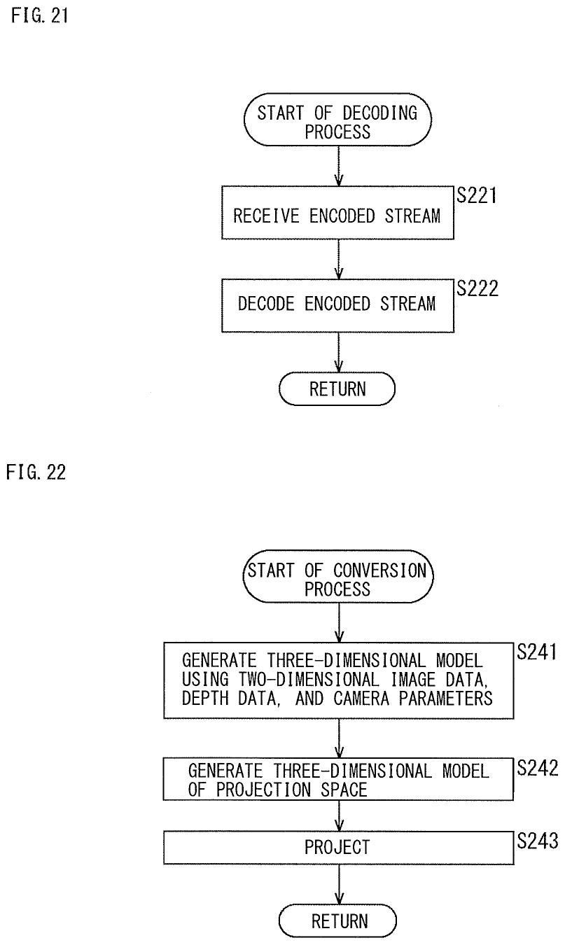

At step S202, the conversion device 42 performs the conversion process. That is, the conversion device 42 generates (reconstructs) a three-dimensional model on the basis of two-dimensional image data and depth data from a predetermined viewpoint in accordance with the metadata supplied from the decoding device 41 and a display image generation scheme employed in the decoding system 12. The conversion device 42 then projects the three-dimensional model to generate display image data. The conversion process will be described below in detail with reference to a flowchart in FIG. 22.

The display image data generated by the conversion device 42 is supplied to the three-dimensional data display device 43.

At step S203, the three-dimensional data display device 43 two- or three-dimensionally displays a display image on the basis of the display image data supplied from the conversion device 42.

Next, the decoding process at step S201 in FIG. 20 will be described with reference to the flowchart in FIG. 21.

At step S221, the reception unit 201 receives the encoded stream transmitted from the transmission unit 72 and supplies the encoded stream to the decoding unit 202.

At step S222, the decoding unit 202 decodes the encoded stream received by the reception unit 201 in accordance with the scheme corresponding to the encoding scheme employed in the encoding unit 71. As a result, the decoding unit 202 acquires the two-dimensional image data and the depth data from the plurality of viewpoints, and the shadow maps and the camera parameters, which are metadata. The decoding unit 202 then supplies the acquired data to the conversion unit 203.

Next, the conversion process at step S202 in FIG. 21 will be described with reference to the flowchart in FIG. 22.

At step S241, the modeling section 221 of the conversion unit 203 generates (reconstructs) a three-dimensional model of the subject using the selected two-dimensional image data, depth data, and camera parameters from the predetermined viewpoint. The three-dimensional model of the subject is supplied to the projection section 223.

At step S242, the projection space model generation section 222 generates a three-dimensional model of projection space using projection space data and a shadow map supplied from the decoding unit 202, and supplies the three-dimensional model of the projection space to the projection section 223.

At step S243, the projection section 223 performs perspective projection of a three-dimensional object corresponding to the three-dimensional model of the projection space and the three-dimensional model of the subject. The projection section 223 uses each of the pixels of the three-dimensional model as a pixel in a corresponding position on a two-dimensional image, thereby to generate two-dimensional image data that associates two-dimensional coordinates of each of the pixels with the image data.

In the description above, a case has been described where the projection space is the same as that at the time of the imaging, which in other words is a case where the projection space data transmitted from the encoding system 11 is used. The following describes an example in which projection space data is generated by the decoding system 12.

### <<6. Modification Example of Decoding System>>

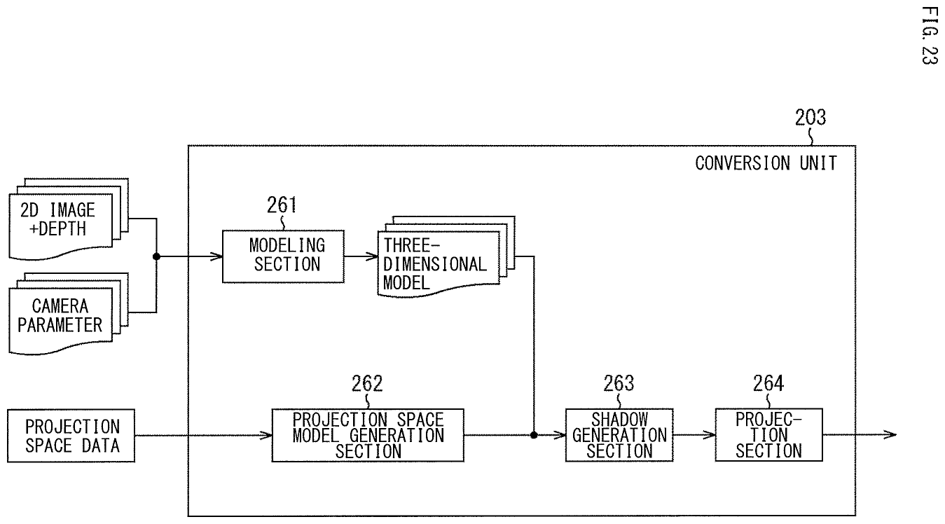

FIG. 23 is a block diagram illustrating an example of another configuration of the conversion unit 203 of the conversion device 42 of the decoding system 12.

The conversion unit 203 in FIG. 23 includes a modeling section 261, a projection space model generation section 262, a shadow generation section 263, and a projection section 264.

Basically, the modeling section 261 has a configuration similar to the configuration of the modeling section 221 in FIG. 12. The modeling section 261 generates a three-dimensional model of the subject by performing modeling by, for example, visual hull using the camera parameters, the two-dimensional image data, and the depth data from the predetermined viewpoint. The generated three-dimensional model of the subject is supplied to the shadow generation section 263.

Data of projection space selected by a user, for example, is inputted to the projection space model generation section 262. The projection space model generation section 262 generates a three-dimensional model of the projection space using the inputted projection space data and supplies the three-dimensional model of the projection space to the shadow generation section 263.

The shadow generation section 263 generates a shadow from a position of a light source in the projection space using the three-dimensional model of the subject supplied from the modeling section 261 and the three-dimensional model of the projection space supplied from the projection space model generation section 262. Methods for generating a shadow in general CG (Computer Graphics) are well-known, such as writing methods in game engines like Unity and Unreal Engine.

The three-dimensional model of the projection space and the three-dimensional model of the subject for which the shadow has been generated are supplied to the projection section 264.

The projection section 264 performs perspective projection of a three-dimensional object corresponding to the three-dimensional model of the projection space and the three-dimensional model of the subject for which the shadow has been generated.

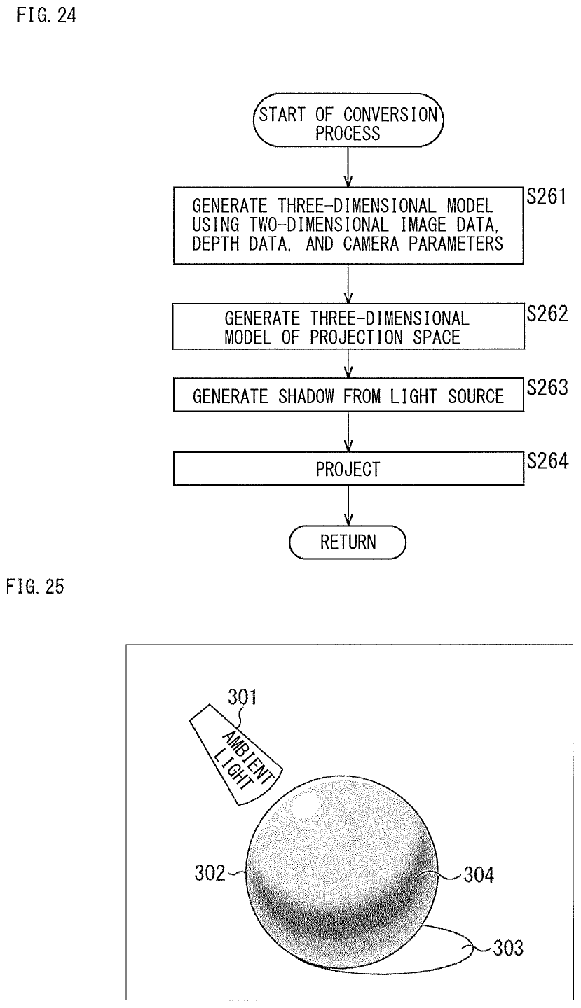

Next, the conversion process in step S202 in FIG. 20 that is performed by the conversion unit 203 in FIG. 23 will be described with reference to a flowchart in FIG. 24.

At step S261, the modeling section 261 generates a three-dimensional model of the subject using the selected two-dimensional image data, depth data, and camera parameters from the predetermined viewpoint. The three-dimensional model of the subject is supplied to the shadow generation section 263.

At step S262, the projection space model generation section 262 generates a three-dimensional model of projection space using projection space data and a shadow map supplied from the decoding unit 202, and supplies the three-dimensional model of the projection space to the shadow generation section 263.

At step S263, the shadow generation section 263 generates a shadow from a position of a light source in the projection space using the three-dimensional model of the subject supplied from the modeling section 261 and the three-dimensional model of the projection space supplied from the projection space model generation section 262.

At step S264, the projection section 264 performs perspective projection of a three-dimensional object corresponding to the three-dimensional model of the projection space and the three-dimensional model of the subject.

Since the present technology enables transmission of the three-dimensional model and the shadow in a separate manner by isolating the shadow from the three-dimensional model as described above, it is possible to select whether to add or remove the shadow at the displaying end.

The shadow at the time of the imaging is not used when the three-dimensional model is projected to three-dimensional space that is different from the three-dimensional space at the time of the imaging. It is therefore possible to display a natural shadow.

It is possible to display a natural shadow when the three-dimensional model is projected to three-dimensional space that is the same as the projection space at the time of the imaging. By then, the shadow is already transmitted, saving time and effort to generate a shadow from a light source.

Since it is acceptable that the shadow is blurred or low-resolution, transmission volume thereof may be very small relative to that of the two-dimensional image data.

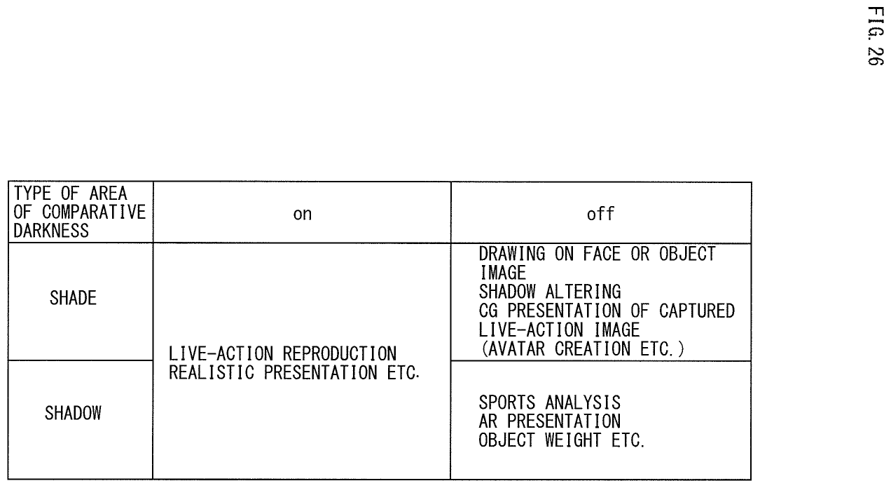

FIG. 25 is a diagram illustrating an example of two types of areas of comparative darkness.

The two types of “areas of comparative darkness” are a shadow and a shade.

Irradiation of an object 302 with ambient light 301 creates a shadow 303 and a shade 304.

The shadow 303 appears with the object 302, being created by the object 302 blocking the ambient light 301 when the object 302 is irradiated with the ambient light 301. The shade 304 appears on an opposite side of the object 302 to a light source side thereof, being created by the ambient light 301 when the object 302 is irradiated with the ambient light 301.

The present technology is applicable both to the shadow and to the shade. In a case where the shadow and the shade are not distinguished from each other, therefore, the term “shadow” is used herein, encompassing the shade as well.

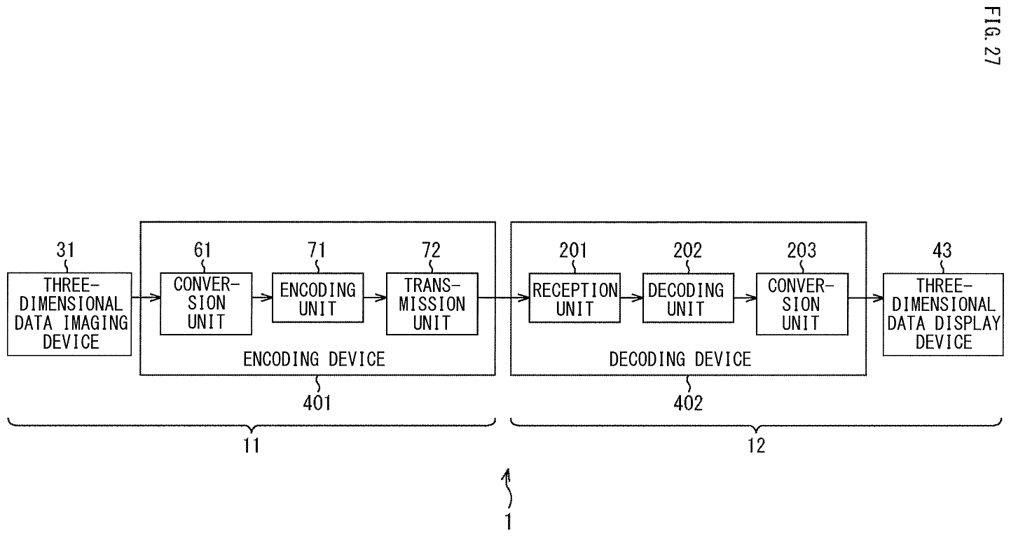

FIG. 26 is a diagram illustrating examples of effects that are produced by addition of the shadow or the shade and by addition of no shadow or no shade. The term “on” indicates effects that are produced by addition of the shadow, the shade, or both. The term “off” with respect to the shade indicates effects that are produced by addition of no shade. The term “off” with respect to the shadow indicates effects that are produced by addition of no shadow.

Addition of the shadow, the shade, or both produces effects for example in live-action reproduction and realistic presentation.

Addition of no shade produces effects in drawing on a face image or an object image, shadow altering, and CG presentation of a captured live-action image.

That is, shadow information is taken off from a three-dimensional model coexisting with a shade, such as a shade of a face, a shade of an arm, clothes, or anything on a person, when the three-dimensional model is displayed. This facilitates the drawing or the shadow altering, enabling easy edit of textures of the three-dimensional model.

In a case where a brown shade on the face is desired to be eliminated while avoiding creation of highlights in imaging of the face, for example, it is possible to eliminate the shade from the face by erasing the shade after emphasizing the shade.

By contrast, addition of no shadow produces effects in sports analysis, AR presentation, and object superimposition.

That is, in sports analysis, for example, transmitting a shadow and a three-dimensional model in a separate manner allows shadow information to be taken off when a textured three-dimensional model of a player is displayed or when AR presentation of the player is performed. It should be noted that commercially available sports analysis software is also able to output a two-dimensional image of the player and information related to the player. In this output, however, the shadow is present at the player's feet.

It is more effective and helpful for visibility in sports analysis that like the present technology, information related to the player, trajectories, and the like are drawn with the shadow information off. In a case of a soccer or basketball game, which naturally involves a plurality of players (objects), removing a shadow prevents the shadow from interfering with other objects.

By contrast, in a case where an image is viewed as a live-action image, the image is more natural and real with shadows.

According to the present technology, as described above, it is possible to select whether to add or remove a shadow, enhancing the convenience for users.

### <<7. Another Configuration Example of Encoding System and Decoding System>>

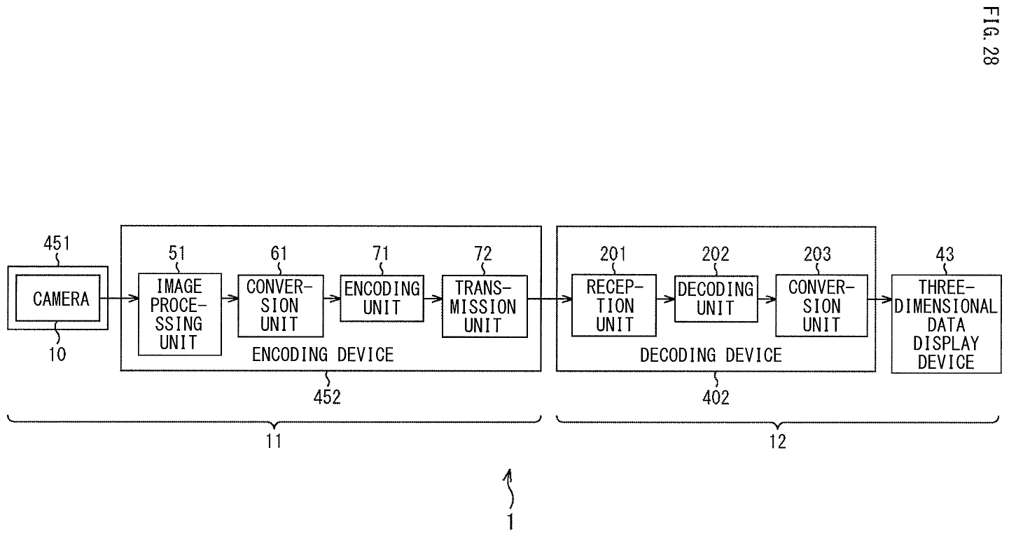

FIG. 27 is a block diagram illustrating an example of another configuration of the encoding system and the decoding system. Out of constituent elements illustrated in FIG. 27, those that are the same as the constituent elements described with reference to FIG. 5 or 11 are given the same reference signs as in FIG. 5 or 11. Redundant description is omitted as appropriate.

The encoding system 11 in FIG. 27 includes the three-dimensional data imaging device 31 and an encoding device 401. The encoding device 401 includes the conversion unit 61, the encoding unit 71, and the transmission unit 72. That is, the encoding device 401 in FIG. 27 has a configuration including the configuration of the encoding device 33 in FIG. 5 and, in addition, the configuration of the conversion device 32 in FIG. 5.

The decoding system 12 in FIG. 27 includes a decoding device 402 and the three-dimensional data display device 43. The decoding device 402 includes the reception unit 201, the decoding unit 202, and the conversion unit 203. That is, the decoding device 402 in FIG. 27 has a configuration including the configuration of the decoding device 41 in FIG. 11 and, in addition, the configuration of the conversion device 42 in FIG. 11.

### <<8. Another Configuration Example of Encoding System and Decoding System>>

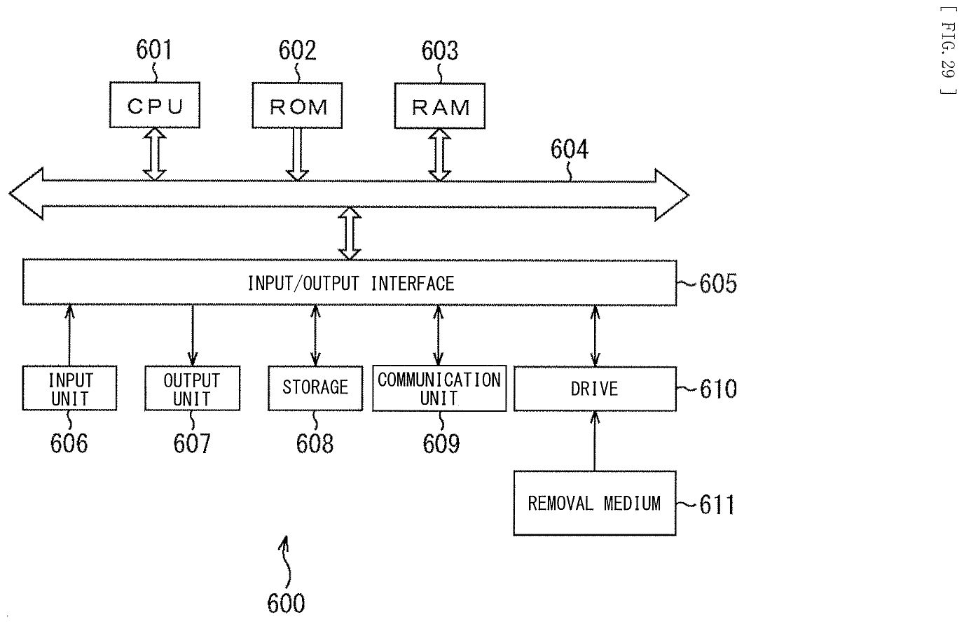

FIG. 28 is a block diagram illustrating an example of yet another configuration of the encoding system and the decoding system. Out of constituent elements illustrated in FIG. 28, those that are the same as the constituent elements described with reference to FIG. 5 or 11 are given the same reference signs as in FIG. 5 or 11. Redundant description is omitted as appropriate.

The encoding system 11 in FIG. 28 includes a three-dimensional data imaging device 451 and an encoding device 452. The three-dimensional data imaging device 451 includes cameras 10. The encoding device 401 includes the image processing unit 51, the conversion unit 61, the encoding unit 71, and the transmission unit 72. That is, the encoding device 452 in FIG. 28 has a configuration including the configuration of the encoding device 401 in FIG. 27 and, in addition, the image processing unit 51 of the three-dimensional data imaging device 31 in FIG. 5.

The decoding system 12 in FIG. 28 includes the decoding device 402 and the three-dimensional data display device 43 as in the configuration illustrated in FIG. 27.

As described above, each of the elements may be included in any device in the encoding system 11 and the decoding system 12.

The above-described series of processes is executable by hardware or software. In a case where the series of processes is executed by software, a program constituting this software is installed on a computer. Examples of computers herein include a computer incorporated into dedicated hardware and a general-purpose personal computer, for example, enabled to execute various functions by installing various programs therein.

### <<9. Example of Computer>>

FIG. 29 is a block diagram illustrating an example of a configuration of hardware of a computer that executes the above-described series of processes through a program.

A computer 600 includes CPU (Central Processing Unit) 601, ROM (Read Only Memory) 602, and RAM (Random Access Memory) 603, which are coupled to one another by a bus 604.

Furthermore, an input/output interface 605 is coupled to the bus 604. An input unit 606, an output unit 607, storage 608, a communication unit 609, and a drive 610 are coupled to the input/output interface 605.

The input unit 606 includes a keyboard, a mouse, and a microphone, for example. The output unit 607 includes a display and a speaker, for example. The storage 608 includes a hard disk and non-volatile memory, for example. The communication unit 609 includes a network interface, for example. The drive 610 drives a removal medium 611 such as a magnetic disk, an optical disk, a magneto-optical disk, or semiconductor memory.

In the computer 600 having the above-described configuration, for example, the above-described series of processes is performed through the CPU 601 loading the program stored in the storage 608 to the RAM 603 via the input/output interface 605 and the bus 604, and executing the program.

The program to be executed by the computer 600 (CPU 601) may for example be recorded in the removal medium 611 serving as a package medium or the like and provided in such a form. The program may alternatively be provided through a wired or wireless transmission medium such as a local area network, the Internet, or digital satellite broadcast.

The program may be installed on the computer 600 by attaching the removal medium 611 to the drive 610 and installing the program on the storage 608 via the input/output interface 605. Alternatively, the program may be received by the communication unit 609 through the wired or wireless transmission medium and installed on the storage 608. Alternatively, the program may be pre-installed on the ROM 602 or the storage 608.

It should be noted that the program to be executed by the computer may be a program to perform the processes chronologically according to the order described herein, a program to concurrently perform the processes, or a program to perform the processes when necessary such as when the program is invoked.

Furthermore, the system herein means a collection of a plurality of constituent elements (devices, modules (parts), and the like), regardless of whether or not all of the constituent elements are in the same housing. That is, a plurality of devices accommodated in separate housings and coupled to each other via a network is a system, and a single device including a plurality of modules accommodated in a single housing is also a system.

It should be noted that the effects described herein are merely exemplary and not limitative, and the present technology may exert other effects.

The embodiments of the present technology are not limited to the above-described embodiments, and various modifications may be made without departing from the gist of the present technology.

For example, the present technology may have a configuration of cloud computing in which a plurality of devices share and jointly process a single function via a network.

Furthermore, each of the steps described with reference to the flowcharts may be performed by a single device or shared and performed by a plurality of devices.

Furthermore, in a case where a single step includes a plurality of processes, the plurality of processes included in the single step may be performed by a single device or shared and performed by a plurality of devices.

The present technology may have any of the following configurations.

(1)

An image processing apparatus including:

a generator that generates two-dimensional image data and depth data on the basis of a three-dimensional model generated from each of viewpoint images of a subject, the viewpoint images being captured through imaging from a plurality of viewpoints and subjected to a shadow removal process; and a transmitter that transmits the two-dimensional image data, the depth data, and shadow information being information related to a shadow of the subject.

(2)

The image processing apparatus according to (1), further including a shadow remover that performs the shadow removal process on each of the viewpoint images, in which

the transmitter transmits information related to the shadow removed through the shadow removal process as the shadow information for each of the viewpoints.

(3)

The image processing apparatus according to (1) or (2), further including a shadow information generator that generates the shadow information from a virtual viewpoint being a position other than camera positions at a time of the imaging.

(4)

The image processing apparatus according to (3), in which the image processing apparatus estimates the virtual viewpoint by performing viewpoint interpolation on the basis of the camera positions at the time of the imaging to generate the shadow information from the virtual viewpoint.

(5)

The image processing apparatus according to any one of (1) to (4), in which the generator uses each of pixels of the three-dimensional model as a pixel in a corresponding position on a two-dimensional image, thereby to generate the two-dimensional image data that associates two-dimensional coordinates of each of the pixels with image data, and uses each of the pixels of the three-dimensional model as a pixel in a corresponding position on the two-dimensional image, thereby to generate the depth data that associates the two-dimensional coordinates of each of the pixels with a depth.

(6)

The image processing apparatus according to any one of (1) to (5), in which at an end where a display image exhibiting the subject is generated, the three-dimensional model is reconstructed on the basis of the two-dimensional image data and the depth data, and the display image is generated by projecting the three-dimensional model to projection space being virtual space, and

the transmitter transmits projection space data and texture data of the projection space, the projection space data being data of a three-dimensional model of the projection space.

(7)

An image processing method including:

generating, by an image processing apparatus, two-dimensional image data and depth data on the basis of a three-dimensional model generated from each of viewpoint images of a subject, the viewpoint images being captured through imaging from a plurality of viewpoints and subjected to a shadow removal process; and

transmitting, by the image processing apparatus, the two-dimensional image data, the depth data, and shadow information being information related to a shadow of the subject.

(8)

An image processing apparatus including:

a receiver that receives two-dimensional image data, depth data, and shadow information, the two-dimensional image data and the depth data being generated on the basis of a three-dimensional model generated from each of viewpoint images of a subject, the viewpoint images being captured through imaging from a plurality of viewpoints and subjected to a shadow removal process, the shadow information being information related to a shadow of the subject; and

a display image generator that generates a display image exhibiting the subject from a predetermined viewpoint, using the three-dimensional model reconstructed on the basis of the two-dimensional image data and the depth data.

(9)

The image processing apparatus according to (8), in which the display image generator generates the display image from the predetermined viewpoint by projecting the three-dimensional model of the subject to projection space being virtual space.

(10)

The image processing apparatus according to (9), in which the display image generator adds the shadow of the subject from the predetermined viewpoint on the basis of the shadow information to generate the display image.

(11)

The image processing apparatus according to (9) or (10), in which the shadow information is information related to the shadow of the subject removed through the shadow removal process for each of the viewpoints, or generated information related to the shadow of the subject from a virtual viewpoint being a position other than camera positions at a time of the imaging.

(12)

The image processing apparatus according to any one of (9) to (11), in which the receiver receives projection space data and texture data of the projection space, the projection space data being data of a three-dimensional model of the projection space, and

the display image generator generates the display image by projecting the three-dimensional model of the subject to the projection space represented by the projection space data.

(13)

The image processing apparatus according to any one of (9) to (12), further including a shadow information generator that generates the information related to the shadow of the subject on the basis of information related to a light source in the projection space, in which

the display image generator adds the generated shadow of the subject to a three-dimensional model of the projection space to generate the display image.

(14)

The image processing apparatus according to any one of (8) to (13), in which the display image generator generates the display image that is to be used for displaying a three-dimensional image or a two-dimensional image.

(15)

An image processing method including:

receiving, by an image processing apparatus, two-dimensional image data, depth data, and shadow information, the two-dimensional image data and the depth data being generated on the basis of a three-dimensional model generated from each of viewpoint images of a subject, the viewpoint images being captured through imaging from a plurality of viewpoints and subjected to a shadow removal process, the shadow information being information related to a shadow of the subject; and

generating, by the image processing apparatus, a display image exhibiting the subject from a specific viewpoint, using the three-dimensional model reconstructed on the basis of the two-dimensional image data and the depth data.

### REFERENCE SIGNS LIST

1: Free-viewpoint image transmission system
10-1 to 10-N: Camera
11: Encoding system
12: Decoding system
31: Two-dimensional data imaging device
32: Conversion device
33: Encoding device
41: Decoding device
42: Conversion device
43: Three-dimensional data display device
51: Image processing unit
16: Conversion unit
71: Encoding unit
72: Transmission unit
101: Camera calibration section
102: Frame synchronization section
103: Background subtraction section
104: Shadow removal section
105: Modeling section
106: Mesh creating section
107: Texture mapping section
121: Shadow map generation section
122: Background subtraction refinement section
181: Camera position determination section
182: Two-dimensional data generating section
183: Shadow map determination section
170: Three-dimensional model
171-1 to 171-N: Virtual camera position
201: Reception unit
202: Decoding unit
203: Conversion unit
204: Display unit
221: Modeling section
222: Projection space model generation section
223: Projection section
261: Modeling section
262: Projection space model generation section
263: Shadow generation section
264: Projection section
401: Encoding device
402: Decoding device
451: Three-dimensional data imaging device
452: Encoding device

1. An image processing apparatus comprising:
a generator that generates two-dimensional image data and depth data on a basis of a three-dimensional model generated from each of viewpoint images of a subject, the viewpoint images being captured through imaging from a plurality of viewpoints and subjected to a shadow removal process; and
a transmitter that transmits the two-dimensional image data, the depth data, and shadow information being information related to a shadow of the subject.

2. The image processing apparatus according to claim 1, further comprising a shadow remover that performs the shadow removal process on each of the viewpoint images, wherein
the transmitter transmits information related to the shadow removed through the shadow removal process as the shadow information for each of the viewpoints.

3. The image processing apparatus according to claim 1, further comprising a shadow information generator that generates the shadow information from a virtual viewpoint being a position other than camera positions at a time of the imaging.

4. The image processing apparatus according to claim 3, wherein the shadow information generator estimates the virtual viewpoint by performing viewpoint interpolation on a basis of the camera positions at the time of the imaging to generate the shadow information from the virtual viewpoint.

5. The image processing apparatus according to claim 1, wherein the generator uses each of pixels of the three-dimensional model as a pixel in a corresponding position on a two-dimensional image, thereby to generate the two-dimensional image data that associates two-dimensional coordinates of each of the pixels with image data, and uses each of the pixels of the three-dimensional model as a pixel in a corresponding position on the two-dimensional image, thereby to generate the depth data that associates the two-dimensional coordinates of each of the pixels with a depth.

6. The image processing apparatus according to claim 1, wherein at an end where a display image exhibiting the subject is generated, the three-dimensional model is reconstructed on a basis of the two-dimensional image data and the depth data, and the display image is generated by projecting the three-dimensional model to projection space being virtual space, and
the transmitter transmits projection space data and texture data of the projection space, the projection space data being data of a three-dimensional model of the projection space.

7. An image processing method comprising:
generating, by an image processing apparatus, two-dimensional image data and depth data on a basis of a three-dimensional model generated from each of viewpoint images of a subject, the viewpoint images being captured through imaging from a plurality of viewpoints and subjected to a shadow removal process; and
transmitting, by the image processing apparatus, the two-dimensional image data, the depth data, and shadow information being information related to a shadow of the subject.

8. An image processing apparatus comprising:
a receiver that receives two-dimensional image data, depth data, and shadow information, the two-dimensional image data and the depth data being generated on a basis of a three-dimensional model generated from each of viewpoint images of a subject, the viewpoint images being captured through imaging from a plurality of viewpoints and subjected to a shadow removal process, the shadow information being information related to a shadow of the subject; and
a display image generator that generates a display image exhibiting the subject from a predetermined viewpoint, using the three-dimensional model reconstructed on a basis of the two-dimensional image data and the depth data.

9. The image processing apparatus according to claim 8, wherein the display image generator generates the display image from the predetermined viewpoint by projecting the three-dimensional model of the subject to projection space being virtual space.

10. The image processing apparatus according to claim 9, wherein the display image generator adds the shadow of the subject from the predetermined viewpoint on a basis of the shadow information to generate the display image.

11. The image processing apparatus according to claim 9, wherein the shadow information is information related to the shadow of the subject removed through the shadow removal process for each of the viewpoints, or generated information related to the shadow of the subject from a virtual viewpoint being a position other than camera positions at a time of the imaging.

12. The image processing apparatus according to claim 9, wherein the receiver receives projection space data and texture data of the projection space, the projection space data being data of a three-dimensional model of the projection space, and
the display image generator generates the display image by projecting the three-dimensional model of the subject to the projection space represented by the projection space data.

13. The image processing apparatus according to claim 9, further comprising a shadow information generator that generates the information related to the shadow of the subject on a basis of information related to a light source in the projection space, wherein
the display image generator adds the generated shadow of the subject to a three-dimensional model of the projection space to generate the display image.

14. The image processing apparatus according to claim 8, wherein the display image generator generates the display image that is to be used for displaying a three-dimensional image or a two-dimensional image.

15. An image processing method comprising:
receiving, by an image processing apparatus, two-dimensional image data, depth data, and shadow information, the two-dimensional image data and the depth data being generated on a basis of a three-dimensional model generated from each of viewpoint images of a subject, the viewpoint images being captured through imaging from a plurality of viewpoints and subjected to a shadow removal process, the shadow information being information related to a shadow of the subject; and
generating, by the image processing apparatus, a display image exhibiting the subject from a predetermined viewpoint, using the three-dimensional model reconstructed on a basis of the two-dimensional image data and the depth data.
